(19) United States
(12) Patent Application Publication
(10) Pub. No.: US 2024/0414339 A1
(43) Pub. Date: Dec. 12, 2024

(54) QUANTIZATION OFFSETS FOR DEPENDENT QUANTIZATION IN VIDEO CODING

(71) Applicant: QUALCOMM Incorporated, San Diego, CA (US)

(72) Inventors: Marta Karczewicz, San Diego, CA (US); Muhammed Zeyd Coban, Carlsbad, CA (US); Pavel Nikitin, München (DE)

(21) Appl. No.: 18/734,509

(22) Filed: Jun. 5, 2024

Related U.S. Application Data
(60) Provisional application No. 63/507,371, filed on Jun. 9, 2023.

(51) Int. Cl. H04N 19/124; H04N 19/176; H04N 19/186; H04N 19/50

(52) U.S. Cl. CPC H04N 19/124; H04N 19/176; H04N 19/186; H04N 19/50

(57) ABSTRACT

A method of processing video data includes determining a quantization level for a coefficient of a current block from a plurality of quantization levels; determining an offset value based on the quantization level, wherein the offset value is a first offset value based on the quantization level being a first quantization level or a second, different offset value based on the quantization level being a second quantization level; determining a quantization parameter or an inverse-quantization parameter for the coefficient based on the determined offset value; and as part of encoding or decoding the current block, performing one of quantization or inverse-quantization for the coefficient based on the determined quantization parameter or the determined inverse-quantization parameter.

This application claims the benefit of U.S. Provisional Application No. 63/507,371, filed Jun. 9, 2023, the entire contents of which are hereby incorporated by reference.

### TECHNICAL FIELD

This disclosure relates to video encoding and video decoding.

### BACKGROUND

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), ITU-T H.265/High Efficiency Video Coding (HEVC), ITU-T H.266/Versatile Video Coding (VVC), and extensions of such standards, as well as proprietary video codecs/formats such as AOMedia Video 1 (AV1) that was developed by the Alliance for Open Media. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video picture or a portion of a video picture) may be partitioned into video blocks, which may also be referred to as coding tree units (CTUs), coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to as reference frames.

### SUMMARY

In general, this disclosure describes techniques for a quantization offset scheme for dependent quantization (e.g., Trellis Coded Quantization). In quantization, a video encoder and a video decoder may determine a quantizer from at least two quantizers to perform quantization (e.g., by the video encoder) or inverse-quantization (e.g., by the video decoder) of coefficient values. The quantizer may determine a multiple by which a coefficient level value of the coefficient is multiplied to determine the quantization parameter or inverse-quantization parameter. The at least two quantizers are referred to as a first quantizer (Q0) or a second quantizer (Q1).

In quantization, the video encoder or video decoder may also determine a quantization level from a plurality of quantization levels to perform quantization (e.g., by the video encoder) or inverse-quantization (e.g., by the video decoder) of coefficient values. The quantization levels may be transform coefficient levels (e.g., based on the coefficient levels of coefficients). The coefficients may be residual values that are transformed, where the residual values may be based on a difference between the actual values of a block and a prediction signal.

In one or more examples, the video encoder and the video decoder may apply different offsets based on a quantization level and/or quantizer for a coefficient to determine the multiple by which the coefficient level value of the coefficient is multiplied to determine the quantization parameter or inverse-quantization parameter. That is, a first offset may be associated with a first quantization level and/or quantizer Q0, and a second, different offset may be associated with a second quantization level and/or quantizer Q1. By applying different offsets based on the quantization level, the example techniques may result in quantizing coefficient values that result in fewer bits that are signaled, while maintaining video quality, as compared to other techniques in which the same offset or no offset is applied to each of the quantization levels. That is, by applying the first offset when the quantization level is a first quantization level, and applying the second offset when the quantization level is a second quantization level, the example techniques may reduce the amount of information that is signaled, as compared to techniques in which the same offset or no offset is applied if the quantization level is the first or second quantization level. In some examples, each quantization level may be associated with a different offset.

In one example, the disclosure describes a method of processing video data, the method comprising: determining a quantization level for a coefficient of a current block from a plurality of quantization levels; determining an offset value based on the quantization level, wherein the offset value is a first offset value based on the quantization level being a first quantization level or a second, different offset value based on the quantization level being a second quantization level; determining a quantization parameter or an inverse-quantization parameter for the coefficient based on the determined offset value; and as part of encoding or decoding the current block, performing one of quantization or inverse-quantization for the coefficient based on the determined quantization parameter or the determined inverse-quantization parameter.

In one example, the disclosure describes a device for processing video data, the device comprising: one or more memories configured to store the video data; and processing circuitry coupled to the one or more memories, wherein the processing circuitry is configured to: determine a quantization level for a coefficient of a current block from a plurality of quantization levels; determine an offset value based on the quantization level, wherein the offset value is a first offset value based on the quantization level being a first quantization level or a second, different offset value based on the quantization level being a second quantization level; determine a quantization parameter or an inverse-quantization parameter for the coefficient based on the determined offset value; and as part of encoding or decoding the current block, perform one of quantization or inverse-quantization for the coefficient based on the determined quantization parameter or the determined inverse-quantization parameter.

In one example, the disclosure describes a computer-readable storage medium storing instructions thereon that when executed cause one or more processors to: determine a quantization level for a coefficient of a current block from a plurality of quantization levels; determine an offset value based on the quantization level, wherein the offset value is a first offset value based on the quantization level being a first quantization level or a second, different offset value based on the quantization level being a second quantization level; determine a quantization parameter or an inverse-quantization parameter for the coefficient based on the determined offset value; and as part of encoding or decoding the current block, perform one of quantization or inverse-quantization for the coefficient based on the determined quantization parameter or the determined inverse-quantization parameter.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example video encoding and decoding system that may perform the techniques of this disclosure.

FIG. 2 is a block diagram illustrating an example video encoder that may perform the techniques of this disclosure.

FIG. 3 is a block diagram illustrating an example video decoder that may perform the techniques of this disclosure.

FIG. 4 is a flowchart illustrating an example method for encoding a current block in accordance with the techniques of this disclosure.

FIG. 5 is a flowchart illustrating an example method for decoding a current block in accordance with the techniques of this disclosure.

FIG. 6 is a conceptual diagram illustrating example of usage of two scalar quantizers.

FIG. 7 is a conceptual diagram illustrating a state transition scheme.

FIG. 8 is a conceptual diagram illustrating another example of usage of two scalar quantizers.

FIG. 9 is a flowchart illustrating a method of operation in accordance with one or more examples of the techniques of this disclosure.

FIG. 10 is a flowchart illustrating a method of operation in accordance with one or more examples of the techniques of this disclosure.

### DETAILED DESCRIPTION

In video encoding, a video encoder determines residual values between a current block being encoded and a prediction block (e.g., determined from samples in another picture for inter-prediction or from samples in same picture for intra-prediction). The video encoder may perform a transform (e.g., discrete cosine transform (DCT)) on the residual values to generate coefficient values. Performing a transform may be optional, and in examples where the transform is skipped, the residual values may be considered as coefficient values. The video encoder performs quantization on the coefficient values based on quantization parameters. The video encoder, after entropy encoding (as an example), signals the quantized coefficient value.

The video decoder performs the inverse process. For instance, the video decoder receives the quantized coefficient values (e.g., after entropy decoding), and inverse-quantizes the coefficient values based on inverse-quantization parameters. The video decoder then performs inverse transform (if needed) to determine the residual values that the video decoder adds to the prediction block (e.g., prediction signal) to reconstruct the current block.

This disclosure describes example techniques related to utilizing quantization offsets for performing quantization or inverse-quantization. Some quantization techniques include quantizers, where the quantizer is based on a state machine scheme. The quantizer may map coefficient level values to multiples of a quantization step size. In accordance with one or more examples described in this disclosure, there may be offsets associated with different quantizers. For instance, assume that there are two quantizers, Q0 and Q1. In some examples, a first offset may be associated with Q0, and a second, different offset may be associated with Q1. There may be more than two quantizers.

Also, quantization techniques include quantization levels (e.g., coefficient levels). In accordance with one or more examples described in this disclosure, there may be offsets associated with different quantization levels. In some examples, a first offset may be associated with a first quantization level, and a second, different offset may be associated with a second quantization level. There may be more than two quantization levels.

Some other techniques may rely on the same offset or no offset for the quantizers or quantization levels. In such other techniques, the amount of quantization applied to a coefficient may be less optimal resulting in insufficient quantization and increased signaling bandwidth, or over quantization and reduced video quality. With the example techniques described in this disclosure, since the offsets based on the quantizer and/or quantization level may be different, the resulting amount of quantization may result in achieving proper balance of reduced signaling bandwidth, while maintaining video quality.

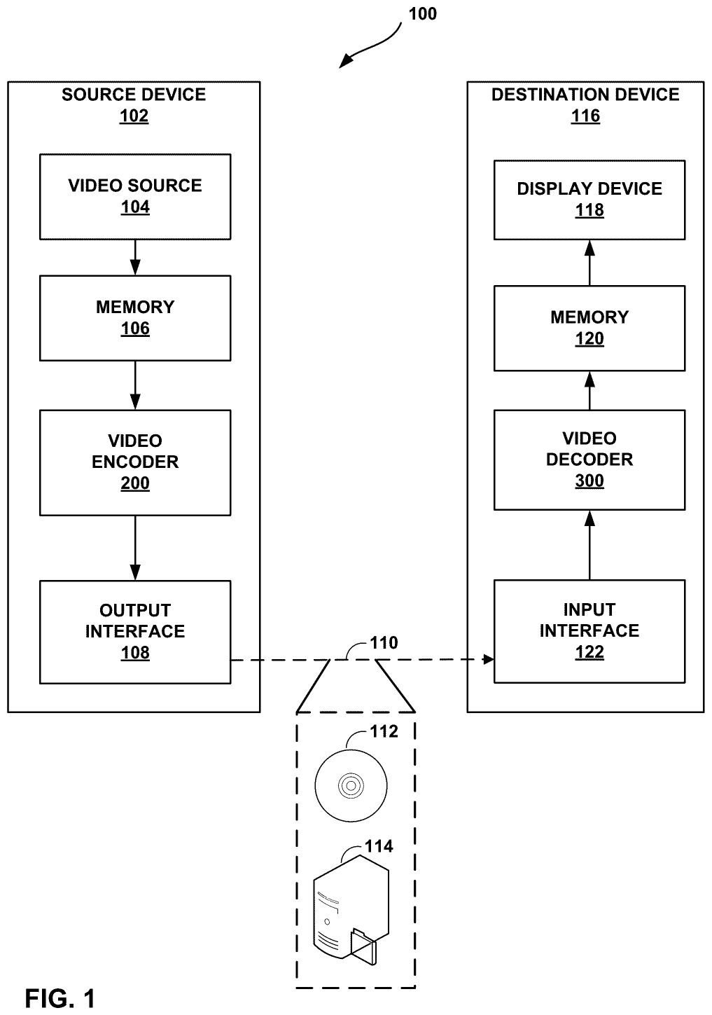

FIG. 1 is a block diagram illustrating an example video encoding and decoding system 100 that may perform the techniques of this disclosure. The techniques of this disclosure are generally directed to coding (encoding and/or decoding) video data. In general, video data includes any data for processing a video. Thus, video data may include raw, unencoded video, encoded video, decoded (e.g., reconstructed) video, and video metadata, such as signaling data.

As shown in FIG. 1, system 100 includes a source device 102 that provides encoded video data to be decoded and displayed by a destination device 116, in this example. In particular, source device 102 provides the video data to destination device 116 via a computer-readable medium 110. Source device 102 and destination device 116 may be or include any of a wide range of devices, such as desktop computers, notebook (i.e., laptop) computers, mobile devices, tablet computers, set-top boxes, telephone handsets such as smartphones, televisions, cameras, display devices, digital media players, video gaming consoles, video streaming device, broadcast receiver devices, or the like. In some cases, source device 102 and destination device 116 may be equipped for wireless communication, and thus may be referred to as wireless communication devices.

In the example of FIG. 1, source device 102 includes video source 104, memory 106, video encoder 200, and output interface 108. Destination device 116 includes input interface 122, video decoder 300, memory 120, and display device 118. In accordance with this disclosure, video encoder 200 of source device 102 and video decoder 300 of destination device 116 may be configured to apply the techniques for quantization, such as quantization offsets for dependent quantization. Thus, source device 102 represents an example of a video encoding device, while destination device 116 represents an example of a video decoding device. In other examples, a source device and a destination device may include other components or arrangements. For example, source device 102 may receive video data from an external video source, such as an external camera. Likewise, destination device 116 may interface with an external display device, rather than include an integrated display device.

System 100 as shown in FIG. 1 is merely one example. In general, any digital video encoding and/or decoding device may perform techniques for quantization, such as quantization offsets for dependent quantization. Source device 102 and destination device 116 are merely examples of such coding devices in which source device 102 generates coded video data for transmission to destination device 116. This disclosure refers to a “coding” device as a device that performs coding (encoding and/or decoding) of data. Thus, video encoder 200 and video decoder 300 represent examples of coding devices, in particular, a video encoder and a video decoder, respectively. In some examples, source device 102 and destination device 116 may operate in a substantially symmetrical manner such that each of source device 102 and destination device 116 includes video encoding and decoding components. Hence, system 100 may support one-way or two-way video transmission between source device 102 and destination device 116, e.g., for video streaming, video playback, video broadcasting, or video telephony.

In general, video source 104 represents a source of video data (i.e., raw, unencoded video data) and provides a sequential series of pictures (also referred to as “frames”) of the video data to video encoder 200, which encodes data for the pictures. Video source 104 of source device 102 may include a video capture device, such as a video camera, a video archive containing previously captured raw video, and/or a video feed interface to receive video from a video content provider. As a further alternative, video source 104 may generate computer graphics-based data as the source video, or a combination of live video, archived video, and computer-generated video. In each case, video encoder 200 encodes the captured, pre-captured, or computer-generated video data. Video encoder 200 may rearrange the pictures from the received order (sometimes referred to as “display order”) into a coding order for coding. Video encoder 200 may generate a bitstream including encoded video data. Source device 102 may then output the encoded video data via output interface 108 onto computer-readable medium 110 for reception and/or retrieval by, e.g., input interface 122 of destination device 116.

Memory 106 of source device 102 and memory 120 of destination device 116 represent general purpose memories. In some examples, memories 106, 120 may store raw video data, e.g., raw video from video source 104 and raw, decoded video data from video decoder 300. Additionally or alternatively, memories 106, 120 may store software instructions executable by, e.g., video encoder 200 and video decoder 300, respectively. Although memory 106 and memory 120 are shown separately from video encoder 200 and video decoder 300 in this example, it should be understood that video encoder 200 and video decoder 300 may also include internal memories for functionally similar or equivalent purposes. Furthermore, memories 106, 120 may store encoded video data, e.g., output from video encoder 200 and input to video decoder 300. In some examples, portions of memories 106, 120 may be allocated as one or more video buffers, e.g., to store raw, decoded, and/or encoded video data.

Computer-readable medium 110 may represent any type of medium or device capable of transporting the encoded video data from source device 102 to destination device 116. In one example, computer-readable medium 110 represents a communication medium to enable source device 102 to transmit encoded video data directly to destination device 116 in real-time, e.g., via a radio frequency network or computer-based network. Output interface 108 may modulate a transmission signal including the encoded video data, and input interface 122 may demodulate the received transmission signal, according to a communication standard, such as a wireless communication protocol. The communication medium may include any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 102 to destination device 116.

In some examples, source device 102 may output encoded data from output interface 108 to storage device 112. Similarly, destination device 116 may access encoded data from storage device 112 via input interface 122. Storage device 112 may include any of a variety of distributed or locally accessed data storage media such as a hard drive, Blu-ray discs, DVDs, CD-ROMs, flash memory, volatile or non-volatile memory, or any other suitable digital storage media for storing encoded video data.

In some examples, source device 102 may output encoded video data to file server 114 or another intermediate storage device that may store the encoded video data generated by source device 102. Destination device 116 may access stored video data from file server 114 via streaming or download.

File server 114 may be any type of server device capable of storing encoded video data and transmitting that encoded video data to the destination device 116. File server 114 may represent a web server (e.g., for a website), a server configured to provide a file transfer protocol service (such as File Transfer Protocol (FTP) or File Delivery over Unidirectional Transport (FLUTE) protocol), a content delivery network (CDN) device, a hypertext transfer protocol (HTTP) server, a Multimedia Broadcast Multicast Service (MBMS) or Enhanced MBMS (cMBMS) server, and/or a network attached storage (NAS) device. File server 114 may, additionally or alternatively, implement one or more HTTP streaming protocols, such as Dynamic Adaptive Streaming over HTTP (DASH), HTTP Live Streaming (HLS), Real Time Streaming Protocol (RTSP), HTTP Dynamic Streaming, or the like.

Destination device 116 may access encoded video data from file server 114 through any standard data connection, including an Internet connection. This may include a wireless channel (e.g., a Wi-Fi connection), a wired connection (e.g., digital subscriber line (DSL), cable modem, etc.), or a combination of both that is suitable for accessing encoded video data stored on file server 114. Input interface 122 may be configured to operate according to any one or more of the various protocols discussed above for retrieving or receiving media data from file server 114, or other such protocols for retrieving media data.

Output interface 108 and input interface 122 may represent wireless transmitters/receivers, modems, wired networking components (e.g., Ethernet cards), wireless communication components that operate according to any of a variety of IEEE 802.11 standards, or other physical components. In examples where output interface 108 and input interface 122 include wireless components, output interface 108 and input interface 122 may be configured to transfer data, such as encoded video data, according to a cellular communication standard, such as 4G, 4G-LTE (Long-Term Evolution), LTE Advanced, 5G, or the like. In some examples where output interface 108 includes a wireless transmitter, output interface 108 and input interface 122 may be configured to transfer data, such as encoded video data, according to other wireless standards, such as an IEEE 802.11 specification, an IEEE 802.15 specification (e.g., ZigBee™), a Bluetooth™ standard, or the like. In some examples, source device 102 and/or destination device 116 may include respective system-on-a-chip (SoC) devices. For example, source device 102 may include an SoC device to perform the functionality attributed to video encoder 200 and/or output interface 108, and destination device 116 may include an SoC device to perform the functionality attributed to video decoder 300 and/or input interface 122.

The techniques of this disclosure may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications.

Input interface 122 of destination device 116 receives an encoded video bitstream from computer-readable medium 110 (e.g., a communication medium, storage device 112, file server 114, or the like). The encoded video bitstream may include signaling information defined by video encoder 200, which is also used by video decoder 300, such as syntax elements having values that describe characteristics and/or processing of video blocks or other coded units (e.g., slices, pictures, groups of pictures, sequences, or the like). Display device 118 displays decoded pictures of the decoded video data to a user. Display device 118 may represent any of a variety of display devices such as a liquid crystal display (LCD), a plasma display, an organic light emitting diode (OLED) display, or another type of display device.

Although not shown in FIG. 1, in some examples, video encoder 200 and video decoder 300 may each be integrated with an audio encoder and/or audio decoder (e.g., audio codec), and may include appropriate MUX-DEMUX units, or other hardware and/or software, to handle multiplexed streams including both audio and video in a common data stream. Example audio codecs may include AAC, AC-3, AC-4, ALAC, ALS, AMBE, AMR, AMR-WB (G.722.2), AMR-WB+, aptx (various versions), ATRAC, BroadVoice (BV16, BV32), CELT, Enhanced AC-3 (E-AC-3), EVS, FLAC, G.711, G.722, G.722.1, G.722.2 (AMR-WB). G.723.1, G.726, G.728, G.729, G.729.1, GSM-FR, HE-AAC, ILBC, iSAC, LA Lyra, Monkey's Audio, MP1, MP2 (MPEG-1, 2 Audio Layer II), MP3, Musepack, Nellymoser Asao, OptimFROG, Opus, Sac, Satin, SBC, SILK, Siren 7, Speex, SVOPC, Truc Audio (TTA), TwinVQ, USAC, Vorbis (Ogg), WavPack, and Windows Media Aud.

Video encoder 200 and video decoder 300 each may be implemented as any of a variety of suitable encoder and/or decoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 200 and video decoder 300 may be included in one or more encoders or decoders, either of which may be integrated as part of a combined encoder/decoder (CODEC) in a respective device. A device including video encoder 200 and/or video decoder 300 may implement video encoder 200 and/or video decoder 300 in processing circuitry such as an integrated circuit and/or a microprocessor. Such a device may be a wireless communication device, such as a cellular telephone, or any other type of device described herein.

Video encoder 200 and video decoder 300 may operate according to a video coding standard, such as ITU-T H.265, also referred to as High Efficiency Video Coding (HEVC) or extensions thereto, such as the multi-view and/or scalable video coding extensions. Alternatively, video encoder 200 and video decoder 300 may operate according to other proprietary or industry standards, such as ITU-T H.266, also referred to as Versatile Video Coding (VVC). In other examples, video encoder 200 and video decoder 300 may operate according to a proprietary video codec/format, such as AOMedia Video 1 (AV1), extensions of AV1, and/or successor versions of AV1 (e.g., AV2). In other examples, video encoder 200 and video decoder 300 may operate according to other proprietary formats or industry standards. The techniques of this disclosure, however, are not limited to any particular coding standard or format. In general, video encoder 200 and video decoder 300 may be configured to perform the techniques of this disclosure in conjunction with any video coding techniques that use quantization or inverse-quantization.

In general, video encoder 200 and video decoder 300 may perform block-based coding of pictures. The term “block” generally refers to a structure including data to be processed (e.g., encoded, decoded, or otherwise used in the encoding and/or decoding process). For example, a block may include a two-dimensional matrix of samples of luminance and/or chrominance data. In general, video encoder 200 and video decoder 300 may code video data represented in a YUV (e.g., Y, Cb, Cr) format. That is, rather than coding red, green, and blue (RGB) data for samples of a picture, video encoder 200 and video decoder 300 may code luminance and chrominance components, where the chrominance components may include both red hue and blue hue chrominance components. In some examples, video encoder 200 converts received RGB formatted data to a YUV representation prior to encoding, and video decoder 300 converts the YUV representation to the RGB format. Alternatively, pre- and post-processing units (not shown) may perform these conversions.

This disclosure may generally refer to coding (e.g., encoding and decoding) of pictures to include the process of encoding or decoding data of the picture. Similarly, this disclosure may refer to coding of blocks of a picture to include the process of encoding or decoding data for the blocks, e.g., prediction and/or residual coding. An encoded video bitstream generally includes a series of values for syntax elements representative of coding decisions (e.g., coding modes) and partitioning of pictures into blocks. Thus, references to coding a picture or a block should generally be understood as coding values for syntax elements forming the picture or block.

HEVC defines various blocks, including coding units (CUs), prediction units (PUs), and transform units (TUs). According to HEVC, a video coder (such as video encoder 200) partitions a coding tree unit (CTU) into CUs according to a quadtree structure. That is, the video coder partitions CTUs and CUs into four equal, non-overlapping squares, and each node of the quadtree has either zero or four child nodes. Nodes without child nodes may be referred to as “leaf nodes,” and CUs of such leaf nodes may include one or more PUs and/or one or more TUs. The video coder may further partition PUs and TUs. For example, in HEVC, a residual quadtree (RQT) represents partitioning of TUs. In HEVC, PUs represent inter-prediction data, while TUs represent residual data. CUs that are intra-predicted include intra-prediction information, such as an intra-mode indication.

As another example, video encoder 200 and video decoder 300 may be configured to operate according to VVC. According to VVC, a video coder (such as video encoder 200) partitions a picture into a plurality of CTUs. Video encoder 200 may partition a CTU according to a tree structure, such as a quadtree-binary tree (QTBT) structure or Multi-Type Tree (MTT) structure. The QTBT structure removes the concepts of multiple partition types, such as the separation between CUs, PUS, and TUs of HEVC. A QTBT structure includes two levels: a first level partitioned according to quadtree partitioning, and a second level partitioned according to binary tree partitioning. A root node of the QTBT structure corresponds to a CTU. Leaf nodes of the binary trees correspond to CUs.

In an MTT partitioning structure, blocks may be partitioned using a quadtree (QT) partition, a binary tree (BT) partition, and one or more types of triple tree (TT) (also called ternary tree (TT)) partitions. A triple or ternary tree partition is a partition where a block is split into three sub-blocks. In some examples, a triple or ternary tree partition divides a block into three sub-blocks without dividing the original block through the center. The partitioning types in MTT (e.g., QT, BT, and TT), may be symmetrical or asymmetrical.

When operating according to the AV1 codec, video encoder 200 and video decoder 300 may be configured to code video data in blocks. In AV1, the largest coding block that can be processed is called a superblock. In AV1, a superblock can be either 128×128 luma samples or 64×64 luma samples. However, in successor video coding formats (e.g., AV2), a superblock may be defined by different (e.g., larger) luma sample sizes. In some examples, a superblock is the top level of a block quadtree. Video encoder 200 may further partition a superblock into smaller coding blocks. Video encoder 200 may partition a superblock and other coding blocks into smaller blocks using square or non-square partitioning. Non-square blocks may include N/2×N, N×N/2, N/4×N, and N×N/4 blocks. Video encoder 200 and video decoder 300 may perform separate prediction and transform processes on each of the coding blocks.

AV1 also defines a tile of video data. A tile is a rectangular array of superblocks that may be coded independently of other tiles. That is, video encoder 200 and video decoder 300 may encode and decode, respectively, coding blocks within a tile without using video data from other tiles. However, video encoder 200 and video decoder 300 may perform filtering across tile boundaries. Tiles may be uniform or non-uniform in size. Tile-based coding may enable parallel processing and/or multi-threading for encoder and decoder implementations.

In some examples, video encoder 200 and video decoder 300 may use a single QTBT or MTT structure to represent each of the luminance and chrominance components, while in other examples, video encoder 200 and video decoder 300 may use two or more QTBT or MTT structures, such as one QTBT/MTT structure for the luminance component and another QTBT/MTT structure for both chrominance components (or two QTBT/MTT structures for respective chrominance components).

Video encoder 200 and video decoder 300 may be configured to use quadtree partitioning, QTBT partitioning, MTT partitioning, superblock partitioning, or other partitioning structures.

In some examples, a CTU includes a coding tree block (CTB) of luma samples, two corresponding CTBs of chroma samples of a picture that has three sample arrays, or a CTB of samples of a monochrome picture or a picture that is coded using three separate color planes and syntax structures used to code the samples. A CTB may be an N×N block of samples for some value of N such that the division of a component into CTBs is a partitioning. A component is an array or single sample from one of the three arrays (luma and two chroma) that compose a picture in 4:2:0, 4:2:2, or 4:4:4 color format or the array or a single sample of the array that compose a picture in monochrome format. In some examples, a coding block is an M×N block of samples for some values of M and N such that a division of a CTB into coding blocks is a partitioning.

The blocks (e.g., CTUs or CUS) may be grouped in various ways in a picture. As one example, a brick may refer to a rectangular region of CTU rows within a particular tile in a picture. A tile may be a rectangular region of CTUs within a particular tile column and a particular tile row in a picture. A tile column refers to a rectangular region of CTUs having a height equal to the height of the picture and a width specified by syntax elements (e.g., such as in a picture parameter set). A tile row refers to a rectangular region of CTUs having a height specified by syntax elements (e.g., such as in a picture parameter set) and a width equal to the width of the picture.

In some examples, a tile may be partitioned into multiple bricks, each of which may include one or more CTU rows within the tile. A tile that is not partitioned into multiple bricks may also be referred to as a brick. However, a brick that is a true subset of a tile may not be referred to as a tile. The bricks in a picture may also be arranged in a slice. A slice may be an integer number of bricks of a picture that may be exclusively contained in a single network abstraction layer (NAL) unit. In some examples, a slice includes either a number of complete tiles or only a consecutive sequence of complete bricks of one tile.

This disclosure may use “N×N” and “N by N” interchangeably to refer to the sample dimensions of a block (such as a CU or other video block) in terms of vertical and horizontal dimensions, e.g., 16×16 samples or 16 by 16 samples. In general, a 16×16 CU will have 16 samples in a vertical direction (y=16) and 16 samples in a horizontal direction (x=16). Likewise, an N×N CU generally has N samples in a vertical direction and N samples in a horizontal direction, where N represents a nonnegative integer value. The samples in a CU may be arranged in rows and columns. Moreover, CUs need not necessarily have the same number of samples in the horizontal direction as in the vertical direction. For example, CUs may include N×M samples, where M is not necessarily equal to N.

Video encoder 200 encodes video data for CUs representing prediction and/or residual information, and other information. The prediction information indicates how the CU is to be predicted in order to form a prediction block for the CU. The residual information generally represents sample-by-sample differences between samples of the CU prior to encoding and the prediction block.

To predict a CU, video encoder 200 may generally form a prediction block for the CU through inter-prediction or intra-prediction. Inter-prediction generally refers to predicting the CU from data of a previously coded picture, whereas intra-prediction generally refers to predicting the CU from previously coded data of the same picture. To perform inter-prediction, video encoder 200 may generate the prediction block using one or more motion vectors. Video encoder 200 may generally perform a motion search to identify a reference block that closely matches the CU, e.g., in terms of differences between the CU and the reference block. Video encoder 200 may calculate a difference metric using a sum of absolute difference (SAD), sum of squared differences (SSD), mean absolute difference (MAD), mean squared differences (MSD), or other such difference calculations to determine whether a reference block closely matches the current CU. In some examples, video encoder 200 may predict the current CU using uni-directional prediction or bi-directional prediction.

Some examples of VVC also provide an affine motion compensation mode, which may be considered an inter-prediction mode. In affine motion compensation mode, video encoder 200 may determine two or more motion vectors that represent non-translational motion, such as zoom in or out, rotation, perspective motion, or other irregular motion types.

To perform intra-prediction, video encoder 200 may select an intra-prediction mode to generate the prediction block. Some examples of VVC provide sixty-seven intra-prediction modes, including various directional modes, as well as planar mode and DC mode. In general, video encoder 200 selects an intra-prediction mode that describes neighboring samples to a current block (e.g., a block of a CU) from which to predict samples of the current block. Such samples may generally be above, above and to the left, or to the left of the current block in the same picture as the current block, assuming video encoder 200 codes CTUs and CUs in raster scan order (left to right, top to bottom).

Video encoder 200 encodes data representing the prediction mode for a current block. For example, for inter-prediction modes, video encoder 200 may encode data representing which of the various available inter-prediction modes is used, as well as motion information for the corresponding mode. For uni-directional or bi-directional inter-prediction, for example, video encoder 200 may encode motion vectors using advanced motion vector prediction (AMVP) or merge mode. Video encoder 200 may use similar modes to encode motion vectors for affine motion compensation mode.

AV1 includes two general techniques for encoding and decoding a coding block of video data. The two general techniques are intra prediction (e.g., intra frame prediction or spatial prediction) and inter prediction (e.g., inter frame prediction or temporal prediction). In the context of AV1, when predicting blocks of a current frame of video data using an intra prediction mode, video encoder 200 and video decoder 300 do not use video data from other frames of video data. For most intra prediction modes, video encoder 200 encodes blocks of a current frame based on the difference between sample values in the current block and predicted values generated from reference samples in the same frame. Video encoder 200 determines predicted values generated from the reference samples based on the intra prediction mode.

Following prediction, such as intra-prediction or inter-prediction of a block, video encoder 200 may calculate residual data for the block. The residual data, such as a residual block, represents sample by sample differences between the block and a prediction block for the block, formed using the corresponding prediction mode. Video encoder 200 may apply one or more transforms to the residual block, to produce transformed data in a transform domain instead of the sample domain. For example, video encoder 200 may apply a discrete cosine transform (DCT), an integer transform, a wavelet transform, or a conceptually similar transform to residual video data. Additionally, video encoder 200 may apply a secondary transform following the first transform, such as a mode-dependent non-separable secondary transform (MDNSST), a signal dependent transform, a Karhunen-Loeve transform (KLT), or the like. Video encoder 200 produces transform coefficients following application of the one or more transforms.

As noted above, following any transforms to produce transform coefficients, video encoder 200 may perform quantization of the transform coefficients. Quantization generally refers to a process in which transform coefficients are quantized to possibly reduce the amount of data used to represent the transform coefficients, providing further compression. By performing the quantization process, video encoder 200 may reduce the bit depth associated with some or all of the transform coefficients. For example, video encoder 200 may round an n-bit value down to an m-bit value during quantization, where n is greater than m. In some examples, to perform quantization, video encoder 200 may perform a bitwise right-shift of the value to be quantized.

Following quantization, video encoder 200 may scan the transform coefficients, producing a one-dimensional vector from the two-dimensional matrix including the quantized transform coefficients. The scan may be designed to place higher energy (and therefore lower frequency) transform coefficients at the front of the vector and to place lower energy (and therefore higher frequency) transform coefficients at the back of the vector. In some examples, video encoder 200 may utilize a predefined scan order to scan the quantized transform coefficients to produce a serialized vector, and then entropy encode the quantized transform coefficients of the vector. In other examples, video encoder 200 may perform an adaptive scan. After scanning the quantized transform coefficients to form the one-dimensional vector, video encoder 200 may entropy encode the one-dimensional vector, e.g., according to context-adaptive binary arithmetic coding (CABAC). Video encoder 200 may also entropy encode values for syntax elements describing metadata associated with the encoded video data for use by video decoder 300 in decoding the video data.

To perform CABAC, video encoder 200 may assign a context within a context model to a symbol to be transmitted. The context may relate to, for example, whether neighboring values of the symbol are zero-valued or not. The probability determination may be based on a context assigned to the symbol.

Video encoder 200 may further generate syntax data, such as block-based syntax data, picture-based syntax data, and sequence-based syntax data, to video decoder 300, e.g., in a picture header, a block header, a slice header, or other syntax data, such as a sequence parameter set (SPS), picture parameter set (PPS), or video parameter set (VPS). Video decoder 300 may likewise decode such syntax data to determine how to decode corresponding video data.

In this manner, video encoder 200 may generate a bitstream including encoded video data, e.g., syntax elements describing partitioning of a picture into blocks (e.g., CUs) and prediction and/or residual information for the blocks. Ultimately, video decoder 300 may receive the bitstream and decode the encoded video data.

In general, video decoder 300 performs a reciprocal process to that performed by video encoder 200 to decode the encoded video data of the bitstream. For example, video decoder 300 may decode values for syntax elements of the bitstream using CABAC in a manner substantially similar to, albeit reciprocal to, the CABAC encoding process of video encoder 200. The syntax elements may define partitioning information for partitioning of a picture into CTUs, and partitioning of each CTU according to a corresponding partition structure, such as a QTBT structure, to define CUs of the CTU. The syntax elements may further define prediction and residual information for blocks (e.g., CUs) of video data.

The residual information may be represented by, for example, quantized transform coefficients. Video decoder 300 may inverse quantize and inverse transform the quantized transform coefficients of a block to reproduce a residual block for the block. Video decoder 300 uses a signaled prediction mode (intra- or inter-prediction) and related prediction information (e.g., motion information for inter-prediction) to form a prediction block for the block. Video decoder 300 may then combine the prediction block and the residual block (on a sample-by-sample basis) to reproduce the original block. Video decoder 300 may perform additional processing, such as performing a deblocking process to reduce visual artifacts along boundaries of the block.

This disclosure may generally refer to “signaling” certain information, such as syntax elements. The term “signaling” may generally refer to the communication of values for syntax elements and/or other data used to decode encoded video data. That is, video encoder 200 may signal values for syntax elements in the bitstream. In general, signaling refers to generating a value in the bitstream. As noted above, source device 102 may transport the bitstream to destination device 116 substantially in real time, or not in real time, such as might occur when storing syntax elements to storage device 112 for later retrieval by destination device 116.

In accordance with the techniques of this disclosure, video encoder 200 and video decoder 300 may be configured to determine quantization offsets. For instance, this disclosure describes examples of a quantization offset scheme for dependent quantization, such as Trellis Coded Quantization (TCQ). For ease, the disclosure describes quantization or quantization parameters used for quantizing as part of video encoding. However, video decoder 300 may perform the inverse operations as video encoder 200, and therefore, may perform inverse-quantization using inverse-quantization parameters. The example techniques may therefore be applicable to both quantizing and inverse-quantizing unless a technique is encoder or decoder side only.

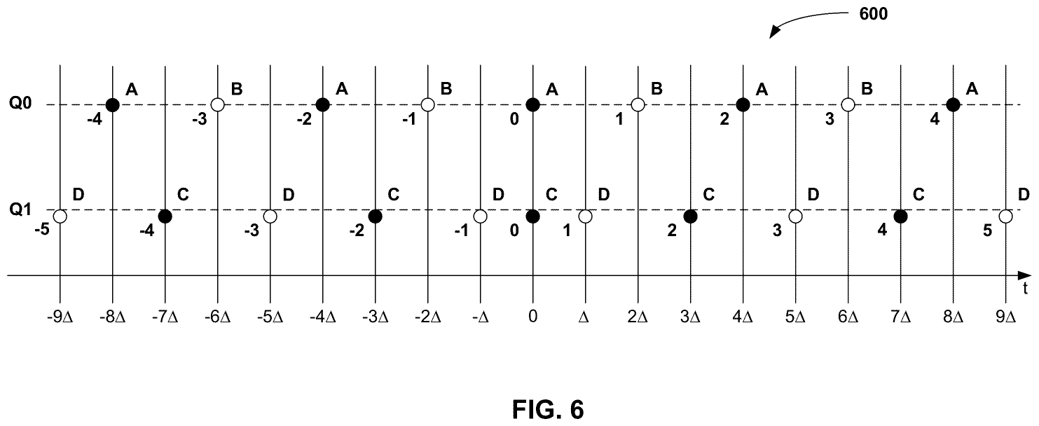

TCQ is a dependent quantization scheme where multiple scalar quantizers are employed to perform quantization of coefficient values. One particular scheme is described in JVET-J0014: Schwarz et al, “Description of SDR, HDR, and 360° video coding technology proposal by Fraunhofer HHI,” Joint Video Experts Team (JVET) of ITU-T SG 16 WP 3 and ISO/IEC JTC 1/SC 29/WG 11, 10th Meeting: San Diego, US, 10-20 Apr. 2018. In JVET-J0014, 4-state Trellis Coded Quantization is used. Two scalar quantizers as shown in FIG. 6 are used for performing the quantization.

FIG. 6 is a conceptual diagram illustrating example of usage of two scalar quantizers. FIG. 6 illustrates quantization level mapping 600. For instance, in quantization level mapping 600 of FIG. 6, of the two scalar quantizers used: the first quantizer Q0 maps the transform coefficient levels, also called quantization levels, (numbers below the points, such as −4, −3, and so forth) to even integer multiples of the quantization step size Δ. The second quantizer Q1 maps the transform coefficient levels to odd integer multiples of the quantization step size Δ or to zero.

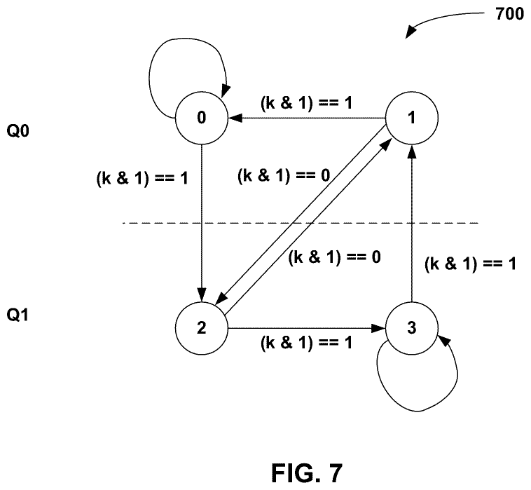

Transform coefficients are quantized in coding order and the quantizer that is used to perform the quantization is selected based on a state machine that is driven by its previous state and the parity of the level of the previously coded coefficient. The state machine is described by FIG. 7.

TABLE 1
provides the transition scheme of state machine 700 of FIG. 7.

| | Next state for . . . | |
|---|---|---|
| Current state | (k & 1) == 0 | (k & 1) == 1 |
| 0 | 0 | 2 |
| 1 | 2 | 0 |
| 2 | 1 | 3 |
| 3 | 3 | 1 |

Coefficients in states 0 and 1 use the Q0 (even integer multiples of step size) quantizer. Coefficients in states 2 and 3 use Q1 (odd integer multiples of step size) quantizer. That is, video encoder 200 and video decoder 300 may quantize or inverse-quantize, as appliable, coefficients using quantizer Q0 (e.g., even integer multiples of step size Δ) if the state of state machine 700 is 0 or 1. Video encoder 200 and video decoder 300 may quantize or inverse-quantize, as appliable, coefficients using quantizer Q1 (e.g., odd integer multiples of step size Δ) if the state of state machine 700 is 2 or 3.

In JVET-Q0243: Schwarz et al, “Additional support of dependent quantization with 8 states,” Joint Video Experts Team (JVET) of ITU-T SG 16 WP 3 and ISO/IEC JTC 1/SC 29/WG 11, 17th Meeting: Brussels, BE, 7-17 Jan. 2020, an 8-state version of TCQ was introduced and is currently in the ECM-9.0 software. In 8-state TCQ, there are still two underlying quantizers (Q0 and Q1), but is driven through 8-state transitioning scheme.

Quantization offset schemes for scalar quantizers had been studied earlier, such as in: VCEG-Z13 (JVT-0066), JCTVC-G382, JCTVC-F610. In JVET-AD0251: Balcilar et al, “AHG12 Shifting Quantizer Center,” Joint Video Experts Team (JVET) of ITU-T SG 16 WP 3 and ISO/IEC JTC 1/SC 29/WG 11, 30th Meeting: Antalya, TR, 21-28 Apr. 2023, fixed quantizer offsets have been proposed. In JVET-AD0251, effectively fixed offsets are introduced as a weighted average of two consecutive reconstruction level of a quantizer (Q0 or Q1).

This scheme is described as follows in JVET-AD0251. The original reconstructed coefficient by Q⁻¹ (yᵢ)) and reconstructed value, when the quantization indices is shifted 1 quantization index to the opposite direction to the zero center as Q⁻¹ (y′ᵢ)) where y′ᵢ=yᵢ+(yᵢ>0?1:−1), is used to determine a reconstructed coefficient. Then, the weighted sum of Q⁻¹ (yᵢ)) and Q⁻¹ (y′ᵢ)) as the reconstructed coefficient is taken.

$$\hat{x} = ( 982 * {Q}^{- 1} ( {y}_{i} ) + 42 * {Q}^{- 1} ( {y}_{i}^{′} ) ) >> 10$$

In some cases, this shifting on reconstruction coefficient is done only if the quantization index is not zero.

Video decoder 300 may be configured to determine the reconstructed coefficient. As described in more detail, video encoder 200, as part of a reconstruction loop for generating reference samples, may also be configured to determine the reconstructed coefficient.

In the above equation, yᵢ may be considered as a coefficient level, also called quantization level, for the i^{th} coefficient. From the perspective of video encoder 200, video encoder 200 may have signaled information used to determine the yᵢ value, and from the perspective of video decoder 300, video decoder 300 may first determine the yᵢ value based on the signaled information. The value of y′ᵢ may be one coefficient level to the left of yᵢ if yᵢ is negative, and one coefficient level to the right of yᵢ if yᵢ is positive. For example, referring to FIG. 6, if yᵢ is 2, then y′ᵢ is 3, and if yᵢ is −4, then y′ᵢ is −5.

Q⁻¹ refers to either Q0 or Q1, and may be based on state machine 700 of FIG. 7. The values of 982 and 42 may be considered as weights for averaging. For example, the >>10 operation is equivalent to dividing by 1024. Therefore, the above equation can be rewritten as \hat{x}=(982/1024)*(Q⁻¹ (yᵢ))+(42/1024)*(Q⁻¹ (y′ᵢ)). That is, this weighted average is effectively a quantization offset that is in between two consecutive reconstruction levels determined by the weights (982/1024, 42/1024).

Given abs (Q⁻¹ (yᵢ)−Q⁻¹ (y′ᵢ))=stepsize, where stepsize is the quantization step size when y ¿ is nonzero, reconstruction expression becomes

$$\hat{x} = stepsize \times ( {y}_{i} + \frac{42}{1024} ) .$$

The 42/1024 term is the quantization offset if all the rounding offsets are ignored due to precision and shift operations instead of division. In JVET-AD0251, this fixed offset is applied to reconstruction of all transform blocks (non-transform skipped blocks).

In the above example, the offset that is added to the quantization level, yᵢ, (also called coefficient level) is the same for both quantizers Q0 and Q1. That is, the quantization parameter may be considered as yᵢ+42/1024, where yᵢ is a quantization level for a coefficient of a current block and 42/1024 is an offset value. In the above example, the offset value of 42/1024 is the same for Q0 and Q1, the same for each of the quantization levels, and the same for luma and chroma components. Also, the same offset value is applied for all quantization levels (e.g., coefficient levels).

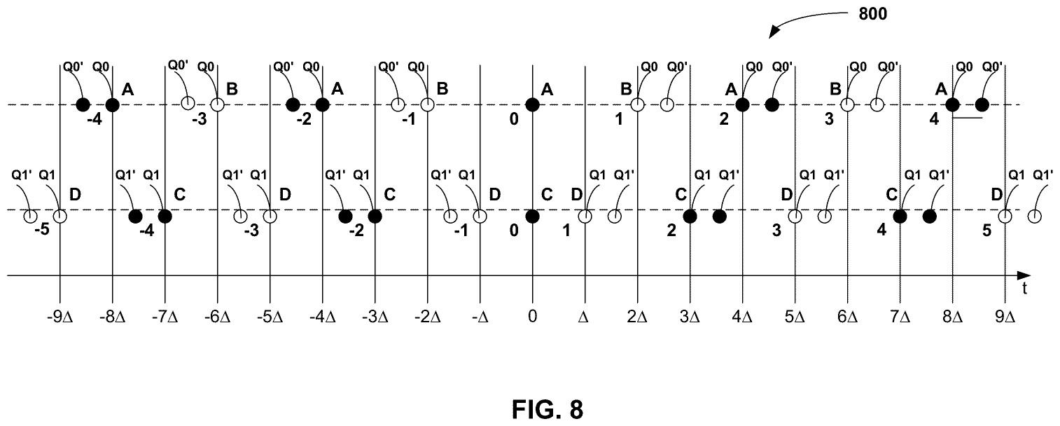

Having a single, same offset value for both quantizers Q0 and Q1, for all of the quantization levels, and/or luma and chroma components may result in less efficient quantization (e.g., over quantization resulting in poor video quality or under quantization resulting in increased signaling). This disclosure describes additional quantization offsets (e.g., for TCQ) based on state driven quantizer type (e.g., Q0 or Q1), quantization levels, and/or component type (luma/chroma). For TCQ case, this would correspond to introducing quantization offsets to Q0 and Q1 resulting in shifting of the reconstruction levels as shown in FIG. 8. The quantizers with offsets and their reconstruction levels are denoted by reconstruction levels Q0′ and reconstruction levels Q1′.

FIG. 8 illustrates quantization level mapping 800. Similar to FIG. 6, in FIG. 8, in quantization level mapping 800 of FIG. 8, of the two scalar quantizers used: the first quantizer Q0′ maps the transform coefficient levels (numbers below the points but offset based on offset values) to even integer multiples of the quantization step size 4. The second quantizer Q1′ maps the transform coefficient levels to odd integer multiples of the quantization step size Δ or to zero.

In one or more examples, with and without signaling, video encoder 200 and video decoder 300 may use separate quantization offsets or inverse-quantization offsets (e.g., offset values) for state driven two quantizers used in TCQ instead of using one common one for both quantizers. Additionally, in some examples, luma and chroma components may use separate offsets for respective quantization.

In accordance with one or more examples described in this disclosure, video encoder 200 and video decoder 300 may determine a quantizer for a coefficient, for quantization or inverse quantization, from at least a first quantizer and a second quantizer. For instance, video encoder 200 and video decoder 300 may utilize state machine 700 of FIG. 7 to determine quantizer Q0 or quantizer Q1.

Video encoder 200 and video decoder 300 may determine an offset value based on the quantizer. In techniques described in this disclosure, the offset value may be a first offset value based on the quantizer being the first quantizer or a second, different offset value based on the quantizer being the second quantizer. That is, if video encoder 200 and video decoder 300 determine that the quantizer is Q0, video encoder 200 and video decoder 300 may determine a first offset value, and if video encoder 200 and video decoder 300 determine that the quantizer is Q1, video encoder 200 and video decoder 300 may determine a second offset value.

Also, in accordance with one or more examples described in this disclosure, video encoder 200 and video decoder 300 may determine a quantization level for a coefficient of a current block, for quantization or inverse quantization, from a plurality of quantization levels. Video encoder 200 may signal and video decoder 300 may parse information to determine the quantization level.

From the perspective of video encoder 200, a coefficient of a current block may mean a residual value between a value of a prediction block and the current block, where the residual value is transformed or not (e.g., if transform skip is enabled). From the perspective of video decoder 300, a coefficient of a current block may mean value that is to be inverse-quantized, inverse-transformed to generate a residual value between a value of a prediction block and the current block.

In one or more examples, as part of encoding the current block, video encoder 200 may perform quantization for the coefficient based on the determined quantization parameter, which is determined based on the offset value, to generate a quantized coefficient. Video encoder 200 may signal information indicative of the quantized coefficient. As part of decoding the current block, video decoder 300 may perform inverse-quantization for the coefficient based on the determined inverse-quantization parameter, which is determined based on the offset value, to generate an inverse-quantized coefficient. Video decoder 300 may perform inverse-transform (if applicable) to generate a residual value that video decoder 300 adds to the prediction block to reconstruct the current block.

Video encoder 200 and video decoder 300 may determine an offset value based on the quantization level. In techniques described in this disclosure, the offset value may be a first offset value based on the quantization level being the first quantization level or a second, different offset value based on the quantization level being the second quantization level. That is, if video encoder 200 and video decoder 300 determine that the quantization level is the first quantization level, video encoder 200 and video decoder 300 may determine a first offset value, and if video encoder 200 and video decoder 300 determine that the quantization level is the second quantization level, video encoder 200 and video decoder 300 may determine a second offset value.

In accordance with the above, in some examples, the quantizer may control the offset value (e.g., first offset value for Q0 and second offset value for Q1). In some examples, the quantization level may control the offset value (e.g., first offset value for first quantization level and second offset value for second quantization level). In some examples, both the quantizer and the quantization level may control the offset value. In some examples, each quantization level may be associated with a different offset value. In some examples, some of the quantization levels may share an offset value, which is different than offset values for other quantization levels.

Approached another way, as described above, in techniques where the offset value is the same, one example way to represent the reconstructed coefficient is:

$$\hat{x} = stepsize \times ( {y}_{i} + \frac{42}{1024} ) .$$

In accordance with one or more examples described in this disclosure, the reconstructed coefficient may be represented as: \hat{x}=stepsize×(yᵢ+offset value), where the offset value is equal to a first offset value if the quantizer is Q0 and is equal to a second, different offset value if the quantizer is Q1 and/or where the offset value is equal to a first offset value if the quantization level is the first quantization level and is equal to a second, different offset value if the quantization level is the second quantization level.

Video encoder 200 and video decoder 300 may determine a quantization parameter or an inverse-quantization parameter for the coefficient based on the determined offset value. For example, video encoder 200 and video decoder 300 may determine yᵢ+offset value, where yᵢ+offset value is equal to the quantization parameter, and the offset value is based on whether the quantizer is Q0 or Q1 and/or based on whether the quantization level is the first quantization level or the second quantization level.

It should be understood that the above examples illustrating mathematical equations are provided to case with understanding. In actual implementation, video encoder 200 and video decoder 300 may perform different operations (e.g., instead of dividing by 1024, perform right-shift operation by 10).

Video encoder 200 and video decoder 300 may perform one of quantization or inverse-quantization for the coefficient based on the determined quantization parameter or the determined inverse-quantization parameter. For example, for quantization, video encoder 200 may determine (yᵢ+offset value)/(step size). For inverse-quantization, video decoder 300 may determine (yᵢ+offset value)*(step size).

In the above examples, the offset value is based on the quantizer. However, as also described above, in some examples, it may be possible for the offset value to be based on the quantization level. That is, there may be different offset values for different quantization level. In some examples, it may be possible for the offset value to be based on both the quantizer and the quantization level.

For example, video encoder 200 and video decoder 300 may determine a quantization level (e.g., yᵢ) for the coefficient. Video decoder 300 may determine the quantization level based on the signaled information. In one or more examples, to determine the offset value, video encoder 200 and video decoder 300 may determine the offset value based on the quantizer and the quantization level.

As an example, assume that there is a first coefficient, an offset value for the first coefficient, a quantizer for the first coefficient, a first quantization parameter and a first inverse-quantization parameter, and a first quantization level. Video encoder 200 and video decoder 300 may determine a quantizer for a second coefficient, for quantization or inverse quantization, from at least the first quantizer and the second quantizer, and determine a second quantization level for the second coefficient, the second quantization level being different than the first quantization level. For instance, if the quantization level for the first coefficient was 2, then the quantization level for the second coefficient may be value other than 2.

Video encoder 200 and video decoder 300 may determine an offset value for the second coefficient based on the quantizer for the second coefficient and the second quantization level. In this example, the offset value for the second coefficient is a third offset value based on the quantizer for the second coefficient being the first quantizer and the second quantization level being different than the first quantization level, or a fourth, different offset value based on the quantizer for the second coefficient being the second quantizer and the second quantization level being different than the first quantization level.

As an example, assume that the first quantizer is Q0 (e.g., based on state machine 700) and the first quantization level is 2. In this example, video encoder 200 and video decoder 300 may determine an offset value of 30/1024. Assume that the second quantizer is also Q0 (e.g., based on state machine 700) but the second quantization level is 4. In this example, video encoder 200 and video decoder 300 may determine an offset value of 50/1024. Accordingly, in addition to the quantizer, the quantization level may control the offset value used to determine the quantization parameter.

Video encoder 200 and video decoder 300 may determine a second quantization parameter or a second inverse-quantization parameter for the second coefficient based on the determined offset value for the second coefficient, similar to the above description. Video encoder 200 and video decoder 300 may perform one of quantization or inverse-quantization for the second coefficient based on the determined second quantization parameter or the determined second inverse-quantization parameter.

As another example, video encoder 200 and video decoder 300 may determine a quantizer for a second coefficient, for quantization or inverse quantization, where the quantizer for the second coefficient is the second quantizer. Video encoder 200 and video decoder 300 may determine that a quantization level for the second coefficient is the first quantization level.

Video encoder 200 and video decoder 300 may determine an offset value for the second coefficient based on the quantizer for the second coefficient being the second quantizer, and the quantization level being the first quantization level. In this example, the offset value for the second coefficient is different than the offset value for the first coefficient based on the quantizer for the first and second coefficient being different, while the quantization level for the first and second coefficient is the same. That is, although the quantization levels for the first and second coefficient is the same, because the quantizer is different for the first and second coefficient, video encoder 200 and video decoder 300 may determine a different offset value for the first and second coefficient.

Video encoder 200 and video decoder 300 may determine a second quantization parameter or a second inverse-quantization parameter for the second coefficient based on the determined offset value for the second coefficient. Video encoder 200 and video decoder 300 may perform one of quantization or inverse-quantization for the second coefficient based on the determined second quantization parameter or the determined second inverse-quantization parameter.

The above is one example way in which quantization level may control the offset value. Additionally, quantization level dependent offsets can be utilized in various other ways. In general, a first offset value may be associated with a first quantization level and a quantizer. The first offset value may be different than offset values associated with the first quantization level and other quantizers. That is, the offset value, when the quantization level is the first quantization level, may be different for Q0 and Q1. A second offset value may be associated with a second quantization level and a quantizer. The second offset value may be different than offset values associated with the second quantization level and other quantizers. That is, the offset value, when the quantization level is the second quantization level, may be different for Q0 and Q1.

The following describes some example ways in which the quantization level may control the offset. In one example, video encoder 200 and video decoder 300 may assign a separate offset for quantization level equal to 1 for the coefficients that are mapped to coefficient level +/−1 (such as in FIG. 8). The rest of the levels are assigned a different quantization offset. This can be applied as separate or common offset for Q0 and Q1. For instance, the first offset may be for when the quantization level is one or negative one. The second offset may be for when the quantization level is greater than one or less than negative one.

Accordingly, as one example, to determine the offset value, video encoder 200 and video decoder 300 may determine that an offset value is a first offset value based on the quantization level being one or negative one. Video encoder 200 and video decoder 300 may determine that an offset value is a second offset value based on the quantization level being greater than one or less than negative one.

Stated another way, the first offset value is associated with the first quantization level, and the first offset value is different than offset values associated with other quantization levels. In one example, the quantization level is one or negative one, and the other quantization levels are greater than one or less than negative one. Similarly, the second offset value is associated with the second quantization level, and the second offset value is different than offset values associated with other quantization levels. As above, in one example, the quantization level is one or negative one, and the other quantization levels are greater than one or less than negative one.

In another example, video encoder 200 and video decoder 300 may assign a separate offset for absolute quantization levels less than a threshold (e.g., 4) and the rest of the levels are assigned a different quantization offset. This can be applied as separate or common offset for Q0 and Q1. Optionally, threshold can be signaled at sequence, picture, or at slice level.

Accordingly, as an example, to determine the offset value, video encoder 200 and video decoder 300 may determine that an offset value is a first offset value based on an absolute value of the quantization level being less than a threshold. Video encoder 200 and video decoder 300 may determine that an offset value is a second offset value based on the quantization level being greater than the threshold.

As an example where both the quantizer and the quantization level are used for determining an offset value, the first offset may be for the first quantizer and an absolute value of the quantization level is less than a threshold (e.g., 4), and the first offset may be different than the offset for the other quantization levels that have an absolute value greater than the threshold when the quantizer is the first quantizer (e.g., Q0). Similarly, the second offset may be for the second quantizer and an absolute value of the quantization level is less than the threshold, and the second offset may be different than the offset for the other quantization levels that have an absolute value greater than the threshold when the quantizer is the second quantizer (e.g., Q1).

Stated another way, the first offset value is associated with the first quantizer and the quantization level, and the first offset value is different than offset values associated with the first quantizer and other quantization levels. In one example, an absolute value of the quantization level is less than a threshold, and an absolute value of the other quantization levels is greater than the threshold. Similarly, the second offset value is associated with the second quantizer and the quantization level, and the second offset value is different than offset values associated with the second quantizer and other quantization levels. As above, in one example, an absolute value of the quantization level is less than the threshold, and an absolute value of the other quantization levels is greater than the threshold.

In another example, video encoder 200 and video decoder 300 may assign a different quantization offset to each level. That is, each of the plurality of quantization levels is associated with (e.g., assigned) a different offset value. Such examples, to determine the offset value, video encoder and video decoder 300 may determine the quantization level, and based on the quantization level determine the offset value.

As an example where both the quantizer and quantization value control which offset value is selected, the first offset may be for the first quantizer, and the first offset may be different than the offset for the other quantization levels when the quantizer is the first quantizer (e.g., Q0). Similarly, the second offset may be for the second quantizer, and the second offset may be different than the offset for the other quantization levels when the quantizer is the second quantizer (e.g., Q1).

Stated another way, each of the first offset value and the offset values associated with the other quantization levels associated with the first quantizer (e.g., Q0) are different. Also, each of the second offset value and the offset values associated with the other quantization levels associated with the second quantizer (e.g., Q1) are different.

In one or more of the above examples, both the quantizer and the quantization level may control the offset value. However, the example techniques are not so limited. In some examples, only the quantizer may control the offset value (e.g., different offset values for Q0 and Q1, but same offset values for the quantization levels). In some examples, only the quantization level may control the offset value (e.g., different offset values for at least two different quantization levels, but same offset values for Q0 and Q1).

For example, video encoder 200 and video decoder 300 may determine a quantization level for a coefficient of a current block, for quantization or inverse quantization, from a plurality of quantization levels (e.g., integer values illustrated in FIGS. 6 and 8). The quantization level may be represented as yᵢ above.

Video encoder 200 and video decoder 300 may determine an offset value based on the quantization level. The offset value is a first offset value based on the quantization level being a first quantization level or a second, different offset value based on the quantization level being a second quantization level.

For instance, the first offset value may be based on the quantization level being 1 or −1, and the second offset value may be based on the quantization level being greater than 1 or less than −1. As another example, the first offset value may be based on an absolute value of the quantization level being less than a threshold (e.g., 4), and the second offset value may be based on an absolute value of the quantization level being greater than the threshold. As another example, the first offset value and the second offset value may always be different (e.g., each quantization level is associated with a different offset value).

Video encoder 200 and video decoder 300 may determine a quantization parameter or an inverse-quantization parameter for the coefficient based on the determined offset value, and perform one of quantization or inverse-quantization for the coefficient based on the determined quantization parameter or the determined inverse-quantization parameter. Accordingly, in this example, the quantization level may control the offset value, regardless of the quantizer. That is, for a quantization level, the offset value is the same for Q0 and Q1, but the offset value may be different for different quantization levels.

Also, in other examples, such as those described further above, both the quantizer and the quantization level may control the offset value. That is, video encoder 200 and video decoder 300 may determine a first offset value for the quantizer being Q0 and the quantization level being a first quantization level, a second offset value for the quantizer being Q1 and the quantization level being the first quantization level, a third offset value for the quantizer being Q0 and the quantization level being a second quantization level, and a fourth offset value for the quantizer being Q1 and the quantization level being the second quantization level. At least two of the first, second, third, and fourth offset values may be different.

In one or more examples, as part of encoding or decoding the current block, video encoder 200 and video decoder 300 may perform one of quantization (e.g., by video encoder 200) or inverse-quantization (e.g., by video decoder 300) for the coefficient based on the determined quantization parameter or the determined inverse-quantization parameter. For example, to encode the current block, video encoder 200 may determine a prediction block for the current block, and determine the coefficient based on a difference between the prediction block and the current block. For instance, the difference between the prediction block and the current block may be a residual value that video encoder 200 transforms or does not transform (e.g., if transform skip is enabled) to generate the coefficient.

In this example, to perform one of quantization or inverse-quantization for the coefficient based on the determined quantization parameter or the determined inverse-quantization parameter, video encoder 200 may perform quantization for the coefficient based on the determined quantization parameter to generate a quantized coefficient. Video encoder 200 may signal information indicative of the quantized coefficient.

As another example, to perform one of quantization or inverse-quantization for the coefficient based on the determined quantization parameter or the determined inverse-quantization parameter, video decoder 300 may perform inverse-quantization for the coefficient based on the determined inverse-quantization parameter to generate an inverse-quantized coefficient. In this example, video decoder 300 may decode the current block. To decode the current block, video decoder 300 may be configured to determine residual values for the current block based on the inverse-quantized coefficient. For instance, if transform is enabled, video decoder 300 may inverse-transform the inverse-quantized coefficient to generate a residual value. If transform skip is enabled, the inverse-quantized coefficient may be the residual value.

In this example, video decoder 300 may determine a prediction block for the current block. Video decoder 300 may add the prediction block to the residual values to reconstruct the current block.

The above example techniques may apply for luma and chroma components. For example, the first offset value may be associated with the first quantizer (e.g., Q0) and the coefficient being for a luma block. In this example, the first offset value may be different than offset values associated with the first quantizer and coefficients being for a chroma block. Similarly, the second offset value may be associated with the second quantizer and the coefficient being for the luma block. In this example, the second offset value may be different than offset values associated with the second quantizer and coefficients being for a chroma block.

The quantization offsets used in above examples can be employed using sequence level, picture level, slice level signaling of the quantization offset. The offsets can be positive or negative. There may be signaling offsets per quantizer (Q0, Q1) per component (Luma, chroma) and per level. For example, video encoder 200 may signal in a bitstream and video decoder 300 may parse from the bitstream the first offset value and the second offset value. Alternatively or additionally, predetermined (not signaled) quantization offsets can be used. Methods where offsets are only signaled for inter pictures (e.g., inter-prediction pictures) can be used.

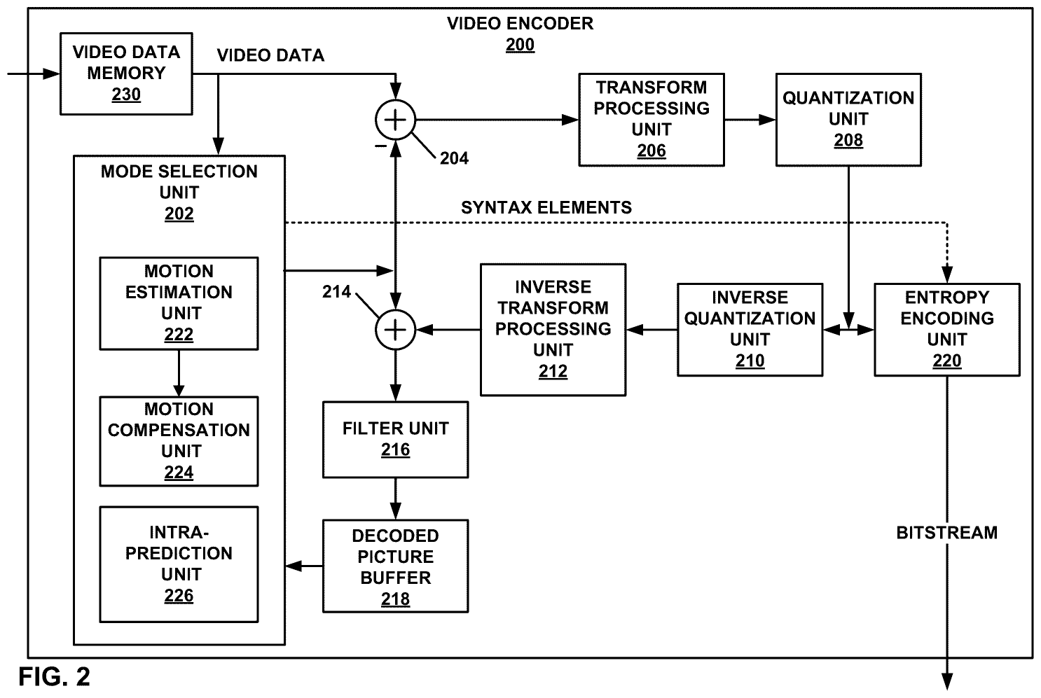

FIG. 2 is a block diagram illustrating an example video encoder 200 that may perform the techniques of this disclosure. FIG. 2 is provided for purposes of explanation and should not be considered limiting of the techniques as broadly exemplified and described in this disclosure. For purposes of explanation, this disclosure describes video encoder 200 according to the techniques of VVC and HEVC. However, the techniques of this disclosure may be performed by video encoding devices that are configured to other video coding standards and video coding formats, such as AV1 and successors to the AV1 video coding format.

In the example of FIG. 2, video encoder 200 includes video data memory 230, mode selection unit 202, residual generation unit 204, transform processing unit 206, quantization unit 208, inverse quantization unit 210, inverse transform processing unit 212, reconstruction unit 214, filter unit 216, decoded picture buffer (DPB) 218, and entropy encoding unit 220. Any or all of video data memory 230, mode selection unit 202, residual generation unit 204, transform processing unit 206, quantization unit 208, inverse quantization unit 210, inverse transform processing unit 212, reconstruction unit 214, filter unit 216, DPB 218, and entropy encoding unit 220 may be implemented in one or more processors or in processing circuitry. For instance, the units of video encoder 200 may be implemented as one or more circuits or logic elements as part of hardware circuitry, or as part of a processor, ASIC, or FPGA. Moreover, video encoder 200 may include additional or alternative processors or processing circuitry to perform these and other functions.

Video data memory 230 may store video data to be encoded by the components of video encoder 200. Video encoder 200 may receive the video data stored in video data memory 230 from, for example, video source 104 (FIG. 1). DPB 218 may act as a reference picture memory that stores reference video data for use in prediction of subsequent video data by video encoder 200. Video data memory 230 and DPB 218 may be formed by any of a variety of memory devices, such as dynamic random access memory (DRAM), including synchronous DRAM (SDRAM), magnetoresistive RAM (MRAM), resistive RAM (RRAM), or other types of memory devices. Video data memory 230 and DPB 218 may be provided by the same memory device or separate memory devices. In various examples, video data memory 230 may be on-chip with other components of video encoder 200, as illustrated, or off-chip relative to those components.

In this disclosure, reference to video data memory 230 should not be interpreted as being limited to memory internal to video encoder 200, unless specifically described as such, or memory external to video encoder 200, unless specifically described as such. Rather, reference to video data memory 230 should be understood as reference memory that stores video data that video encoder 200 receives for encoding (e.g., video data for a current block that is to be encoded). Memory 106 of FIG. 1 may also provide temporary storage of outputs from the various units of video encoder 200.

The various units of FIG. 2 are illustrated to assist with understanding the operations performed by video encoder 200. The units may be implemented as fixed-function circuits, programmable circuits, or a combination thereof. Fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video encoder 200 may include arithmetic logic units (ALUs), elementary function units (EFUs), digital circuits, analog circuits, and/or programmable cores, formed from programmable circuits. In examples where the operations of video encoder 200 are performed using software executed by the programmable circuits, memory 106 (FIG. 1) may store the instructions (e.g., object code) of the software that video encoder 200 receives and executes, or another memory within video encoder 200 (not shown) may store such instructions.

Video data memory 230 is configured to store received video data. Video encoder 200 may retrieve a picture of the video data from video data memory 230 and provide the video data to residual generation unit 204 and mode selection unit 202. Video data in video data memory 230 may be raw video data that is to be encoded.

Mode selection unit 202 includes a motion estimation unit 222, a motion compensation unit 224, and an intra-prediction unit 226. Mode selection unit 202 may include additional functional units to perform video prediction in accordance with other prediction modes. As examples, mode selection unit 202 may include a palette unit, an intra-block copy unit (which may be part of motion estimation unit 222 and/or motion compensation unit 224), an affine unit, a linear model (LM) unit, or the like.

Mode selection unit 202 generally coordinates multiple encoding passes to test combinations of encoding parameters and resulting rate-distortion values for such combinations. The encoding parameters may include partitioning of CTUs into CUs, prediction modes for the CUS, transform types for residual data of the CUs, quantization parameters for residual data of the CUs, and so on. Mode selection unit 202 may ultimately select the combination of encoding parameters having rate-distortion values that are better than the other tested combinations.

Video encoder 200 may partition a picture retrieved from video data memory 230 into a series of CTUs, and encapsulate one or more CTUs within a slice. Mode selection unit 202 may partition a CTU of the picture in accordance with a tree structure, such as the MTT structure, QTBT structure. superblock structure, or the quadtree structure described above. As described above, video encoder 200 may form one or more CUs from partitioning a CTU according to the tree structure. Such a CU may also be referred to generally as a “video block” or “block.”

In general, mode selection unit 202 also controls the components thereof (e.g., motion estimation unit 222, motion compensation unit 224, and intra-prediction unit 226) to generate a prediction block for a current block (e.g., a current CU, or in HEVC, the overlapping portion of a PU and a TU). For inter-prediction of a current block, motion estimation unit 222 may perform a motion search to identify one or more closely matching reference blocks in one or more reference pictures (e.g., one or more previously coded pictures stored in DPB 218). In particular, motion estimation unit 222 may calculate a value representative of how similar a potential reference block is to the current block, e.g., according to sum of absolute difference (SAD), sum of squared differences (SSD), mean absolute difference (MAD), mean squared differences (MSD), or the like. Motion estimation unit 222 may generally perform these calculations using sample-by-sample differences between the current block and the reference block being considered. Motion estimation unit 222 may identify a reference block having a lowest value resulting from these calculations, indicating a reference block that most closely matches the current block.

Motion estimation unit 222 may form one or more motion vectors (MVs) that defines the positions of the reference blocks in the reference pictures relative to the position of the current block in a current picture. Motion estimation unit 222 may then provide the motion vectors to motion compensation unit 224. For example, for uni-directional inter-prediction, motion estimation unit 222 may provide a single motion vector, whereas for bi-directional inter-prediction, motion estimation unit 222 may provide two motion vectors. Motion compensation unit 224 may then generate a prediction block using the motion vectors. For example, motion compensation unit 224 may retrieve data of the reference block using the motion vector. As another example, if the motion vector has fractional sample precision, motion compensation unit 224 may interpolate values for the prediction block according to one or more interpolation filters. Moreover, for bi-directional inter-prediction, motion compensation unit 224 may retrieve data for two reference blocks identified by respective motion vectors and combine the retrieved data, e.g., through sample-by-sample averaging or weighted averaging.

When operating according to the AV1 video coding format, motion estimation unit 222 and motion compensation unit 224 may be configured to encode coding blocks of video data (e.g., both luma and chroma coding blocks) using translational motion compensation, affine motion compensation, overlapped block motion compensation (OBMC), and/or compound inter-intra prediction.

As another example, for intra-prediction, or intra-prediction coding, intra-prediction unit 226 may generate the prediction block from samples neighboring the current block. For example, for directional modes, intra-prediction unit 226 may generally mathematically combine values of neighboring samples and populate these calculated values in the defined direction across the current block to produce the prediction block. As another example, for DC mode, intra-prediction unit 226 may calculate an average of the neighboring samples to the current block and generate the prediction block to include this resulting average for each sample of the prediction block.

When operating according to the AV1 video coding format, intra-prediction unit 226 may be configured to encode coding blocks of video data (e.g., both luma and chroma coding blocks) using directional intra prediction, non-directional intra prediction, recursive filter intra prediction, chroma-from-luma (CFL) prediction, intra block copy (IBC), and/or color palette mode. Mode selection unit 202 may include additional functional units to perform video prediction in accordance with other prediction modes.

Mode selection unit 202 provides the prediction block to residual generation unit 204. Residual generation unit 204 receives a raw, unencoded version of the current block from video data memory 230 and the prediction block from mode selection unit 202. Residual generation unit 204 calculates sample-by-sample differences between the current block and the prediction block. The resulting sample-by-sample differences define a residual block for the current block. In some examples, residual generation unit 204 may also determine differences between sample values in the residual block to generate a residual block using residual differential pulse code modulation (RDPCM). In some examples, residual generation unit 204 may be formed using one or more subtractor circuits that perform binary subtraction.

In examples where mode selection unit 202 partitions CUs into PUs, each PU may be associated with a luma prediction unit and corresponding chroma prediction units. Video encoder 200 and video decoder 300 may support PUs having various sizes. As indicated above, the size of a CU may refer to the size of the luma coding block of the CU and the size of a PU may refer to the size of a luma prediction unit of the PU. Assuming that the size of a particular CU is 2N×2N, video encoder 200 may support PU sizes of 2N×2N or N×N for intra prediction, and symmetric PU sizes of 2N×2N, 2N×N, N×2N, N×N, or similar for inter prediction. Video encoder 200 and video decoder 300 may also support asymmetric partitioning for PU sizes of 2N×nU, 2N×nD, nL×2N, and nR×2N for inter prediction.

In examples where mode selection unit 202 does not further partition a CU into PUs, each CU may be associated with a luma coding block and corresponding chroma coding blocks. As above, the size of a CU may refer to the size of the luma coding block of the CU. The video encoder 200 and video decoder 300 may support CU sizes of 2N×2N, 2N×N, or N×2N.

For other video coding techniques such as an intra-block copy mode coding, an affine-mode coding, and linear model (LM) mode coding, as some examples, mode selection unit 202, via respective units associated with the coding techniques, generates a prediction block for the current block being encoded. In some examples, such as palette mode coding, mode selection unit 202 may not generate a prediction block, and instead generate syntax elements that indicate the manner in which to reconstruct the block based on a selected palette. In such modes, mode selection unit 202 may provide these syntax elements to entropy encoding unit 220 to be encoded.

As described above, residual generation unit 204 receives the video data for the current block and the corresponding prediction block. Residual generation unit 204 then generates a residual block for the current block. To generate the residual block, residual generation unit 204 calculates sample-by-sample differences between the prediction block and the current block.

Transform processing unit 206 applies one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a discrete cosine transform (DCT), a directional transform, a Karhunen-Loeve transform (KLT), or a conceptually similar transform to a residual block. In some examples, transform processing unit 206 may perform multiple transforms to a residual block, e.g., a primary transform and a secondary transform, such as a rotational transform. In some examples, transform processing unit 206 does not apply transforms to a residual block.

When operating according to AV1, transform processing unit 206 may apply one or more transforms to the residual block to generate a block of transform coefficients (referred to herein as a “transform coefficient block”). Transform processing unit 206 may apply various transforms to a residual block to form the transform coefficient block. For example, transform processing unit 206 may apply a horizontal/vertical transform combination that may include a discrete cosine transform (DCT), an asymmetric discrete sine transform (ADST), a flipped ADST (e.g., an ADST in reverse order), and an identity transform (IDTX). When using an identity transform, the transform is skipped in one of the vertical or horizontal directions. In some examples, transform processing may be skipped.

Quantization unit 208 may quantize the transform coefficients in a transform coefficient block, to produce a quantized transform coefficient block. Quantization unit 208 may quantize transform coefficients of a transform coefficient block according to a quantization parameter (QP) value associated with the current block. Video encoder 200 (e.g., via mode selection unit 202) may adjust the degree of quantization applied to the transform coefficient blocks associated with the current block by adjusting the QP value associated with the CU. Quantization may introduce loss of information, and thus, quantized transform coefficients may have lower precision than the original transform coefficients produced by transform processing unit 206.

Inverse quantization unit 210 and inverse transform processing unit 212 may apply inverse quantization and inverse transforms to a quantized transform coefficient block, respectively, to reconstruct a residual block from the transform coefficient block. Reconstruction unit 214 may produce a reconstructed block corresponding to the current block (albeit potentially with some degree of distortion) based on the reconstructed residual block and a prediction block generated by mode selection unit 202. For example, reconstruction unit 214 may add samples of the reconstructed residual block to corresponding samples from the prediction block generated by mode selection unit 202 to produce the reconstructed block.

Filter unit 216 may perform one or more filter operations on reconstructed blocks. For example, filter unit 216 may perform deblocking operations to reduce blockiness artifacts along edges of CUs. Operations of filter unit 216 may be skipped, in some examples.

When operating according to AV1, filter unit 216 may perform one or more filter operations on reconstructed blocks. For example, filter unit 216 may perform deblocking operations to reduce blockiness artifacts along edges of CUs. In other examples, filter unit 216 may apply a constrained directional enhancement filter (CDEF), which may be applied after deblocking, and may include the application of non-separable, non-linear, low-pass directional filters based on estimated edge directions. Filter unit 216 may also include a loop restoration filter, which is applied after CDEF, and may include a separable symmetric normalized Wiener filter or a dual self-guided filter.

Video encoder 200 stores reconstructed blocks in DPB 218. For instance, in examples where operations of filter unit 216 are not performed, reconstruction unit 214 may store reconstructed blocks to DPB 218. In examples where operations of filter unit 216 are performed, filter unit 216 may store the filtered reconstructed blocks to DPB 218. Motion estimation unit 222 and motion compensation unit 224 may retrieve a reference picture from DPB 218, formed from the reconstructed (and potentially filtered) blocks, to inter-predict blocks of subsequently encoded pictures. In addition, intra-prediction unit 226 may use reconstructed blocks in DPB 218 of a current picture to intra-predict other blocks in the current picture.

In general, entropy encoding unit 220 may entropy encode syntax elements received from other functional components of video encoder 200. For example, entropy encoding unit 220 may entropy encode quantized transform coefficient blocks from quantization unit 208. As another example, entropy encoding unit 220 may entropy encode prediction syntax elements (e.g., motion information for inter-prediction or intra-mode information for intra-prediction) from mode selection unit 202. Entropy encoding unit 220 may perform one or more entropy encoding operations on the syntax elements, which are another example of video data, to generate entropy-encoded data. For example, entropy encoding unit 220 may perform a context-adaptive variable length coding (CAVLC) operation, a CABAC operation, a variable-to-variable (V2V) length coding operation, a syntax-based context-adaptive binary arithmetic coding (SBAC) operation, a Probability Interval Partitioning Entropy (PIPE) coding operation, an Exponential-Golomb encoding operation, or another type of entropy encoding operation on the data. In some examples, entropy encoding unit 220 may operate in bypass mode where syntax elements are not entropy encoded.

Video encoder 200 may output a bitstream that includes the entropy encoded syntax elements needed to reconstruct blocks of a slice or picture. In particular, entropy encoding unit 220 may output the bitstream.

In accordance with AV1, entropy encoding unit 220 may be configured as a symbol-to-symbol adaptive multi-symbol arithmetic coder. A syntax element in AV1 includes an alphabet of N elements, and a context (e.g., probability model) includes a set of N probabilities. Entropy encoding unit 220 may store the probabilities as n-bit (e.g., 15-bit) cumulative distribution functions (CDFs). Entropy encoding unit 220 may perform recursive scaling, with an update factor based on the alphabet size, to update the contexts.

The operations described above are described with respect to a block. Such description should be understood as being operations for a luma coding block and/or chroma coding blocks. As described above, in some examples, the luma coding block and chroma coding blocks are luma and chroma components of a CU. In some examples, the luma coding block and the chroma coding blocks are luma and chroma components of a PU.

In some examples, operations performed with respect to a luma coding block need not be repeated for the chroma coding blocks. As one example, operations to identify a motion vector (MV) and reference picture for a luma coding block need not be repeated for identifying a MV and reference picture for the chroma blocks. Rather, the MV for the luma coding block may be scaled to determine the MV for the chroma blocks, and the reference picture may be the same. As another example, the intra-prediction process may be the same for the luma coding block and the chroma coding blocks.

Video encoder 200 represents an example of a device configured to encode video data including a memory configured to store video data, and one or more processing units implemented in circuitry and configured to determine a quantization level for a coefficient of a current block, for quantization or inverse quantization, from a plurality of quantization levels, determine an offset value based on the quantization level, wherein the offset value is a first offset value based on the quantization level being a first quantization level or a second, different offset value based on the quantization level being a second quantization level, determine a quantization parameter for the coefficient based on the determined offset value, and perform quantization for the coefficient based on the determined quantization parameter.

Also, video encoder 200 represents an example of a device configured to encode video data including a memory configured to store video data, and one or more processing units implemented in circuitry and configured to determine a quantizer for a coefficient, for quantization, from at least a first quantizer and a second quantizer, determine an offset value based on the quantizer, wherein the offset value is a first offset value based on the quantizer being the first quantizer or a second, different offset value based on the quantizer being the second quantizer, determine a quantization parameter for the coefficient based on the determined offset value, and perform quantization for the coefficient based on the determined quantization parameter.

Also, video encoder 200 represents an example of a device configured to encode video data including a memory configured to store video data, and one or more processing units implemented in circuitry and configured to determine a first quantizer for a first coefficient of a luma component of a current block, for quantization, determine a first offset value for the first coefficient, determine a first quantization parameter for the first coefficient based on the determined first quantizer and the first offset value, perform quantization for the first coefficient based on the determined first quantization parameter, determine a second quantizer for a second coefficient of a chroma component of the current block, for quantization, determine a second offset value for the second coefficient, the second offset value being different than the first offset value, determine a second quantization parameter for the second coefficient based on the determined second quantizer and the second offset value, perform quantization for the second coefficient based on the determined second quantization parameter.

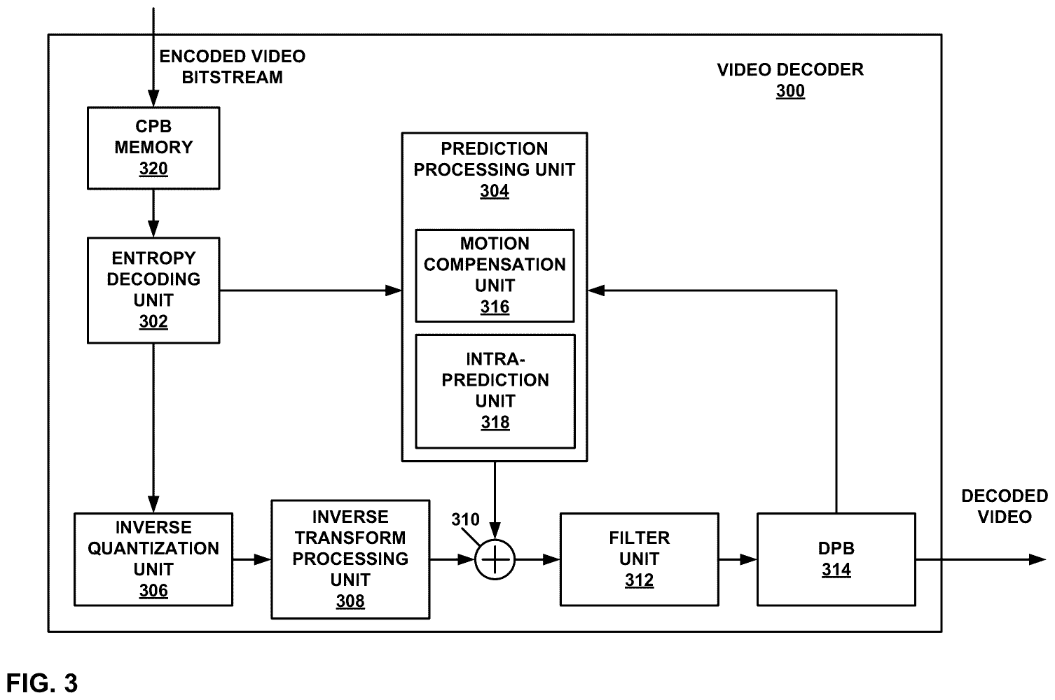

FIG. 3 is a block diagram illustrating an example video decoder 300 that may perform the techniques of this disclosure. FIG. 3 is provided for purposes of explanation and is not limiting on the techniques as broadly exemplified and described in this disclosure. For purposes of explanation, this disclosure describes video decoder 300 according to the techniques of VVC and HEVC. However, the techniques of this disclosure may be performed by video coding devices that are configured to other video coding standards.

In the example of FIG. 3, video decoder 300 includes coded picture buffer (CPB) memory 320, entropy decoding unit 302, prediction processing unit 304, inverse quantization unit 306, inverse transform processing unit 308, reconstruction unit 310, filter unit 312, and DPB 314. Any or all of CPB memory 320, entropy decoding unit 302, prediction processing unit 304, inverse quantization unit 306, inverse transform processing unit 308, reconstruction unit 310, filter unit 312, and DPB 314 may be implemented in one or more processors or in processing circuitry. For instance, the units of video decoder 300 may be implemented as one or more circuits or logic elements as part of hardware circuitry, or as part of a processor, ASIC, or FPGA. Moreover, video decoder 300 may include additional or alternative processors or processing circuitry to perform these and other functions.

Prediction processing unit 304 includes motion compensation unit 316 and intra-prediction unit 318. Prediction processing unit 304 may include additional units to perform prediction in accordance with other prediction modes. As examples, prediction processing unit 304 may include a palette unit, an intra-block copy unit (which may form part of motion compensation unit 316), an affine unit, a linear model (LM) unit, or the like. In other examples, video decoder 300 may include more, fewer, or different functional components.

When operating according to AV1, motion compensation unit 316 may be configured to decode coding blocks of video data (e.g., both luma and chroma coding blocks) using translational motion compensation, affine motion compensation, OBMC, and/or compound inter-intra prediction, as described above. Intra-prediction unit 318 may be configured to decode coding blocks of video data (e.g., both luma and chroma coding blocks) using directional intra prediction, non-directional intra prediction, recursive filter intra prediction, CFL, IBC, and/or color palette mode, as described above.

CPB memory 320 may store video data, such as an encoded video bitstream, to be decoded by the components of video decoder 300. The video data stored in CPB memory 320 may be obtained, for example, from computer-readable medium 110 (FIG. 1). CPB memory 320 may include a CPB that stores encoded video data (e.g., syntax elements) from an encoded video bitstream. Also, CPB memory 320 may store video data other than syntax elements of a coded picture, such as temporary data representing outputs from the various units of video decoder 300. DPB 314 generally stores decoded pictures, which video decoder 300 may output and/or use as reference video data when decoding subsequent data or pictures of the encoded video bitstream. CPB memory 320 and DPB 314 may be formed by any of a variety of memory devices, such as DRAM, including SDRAM, MRAM, RRAM, or other types of memory devices. CPB memory 320 and DPB 314 may be provided by the same memory device or separate memory devices. In various examples, CPB memory 320 may be on-chip with other components of video decoder 300, or off-chip relative to those components.

Additionally or alternatively, in some examples, video decoder 300 may retrieve coded video data from memory 120 (FIG. 1). That is, memory 120 may store data as discussed above with CPB memory 320. Likewise, memory 120 may store instructions to be executed by video decoder 300, when some or all of the functionality of video decoder 300 is implemented in software to be executed by processing circuitry of video decoder 300.

The various units shown in FIG. 3 are illustrated to assist with understanding the operations performed by video decoder 300. The units may be implemented as fixed-function circuits, programmable circuits, or a combination thereof. Similar to FIG. 2, fixed-function circuits refer to circuits that provide particular functionality, and are preset on the operations that can be performed. Programmable circuits refer to circuits that can be programmed to perform various tasks, and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function circuits perform are generally immutable. In some examples, one or more of the units may be distinct circuit blocks (fixed-function or programmable), and in some examples, one or more of the units may be integrated circuits.

Video decoder 300 may include ALUs, EFUs, digital circuits, analog circuits, and/or programmable cores formed from programmable circuits. In examples where the operations of video decoder 300 are performed by software executing on the programmable circuits, on-chip or off-chip memory may store instructions (e.g., object code) of the software that video decoder 300 receives and executes.

Entropy decoding unit 302 may receive encoded video data from the CPB and entropy decode the video data to reproduce syntax elements. Prediction processing unit 304, inverse quantization unit 306, inverse transform processing unit 308, reconstruction unit 310, and filter unit 312 may generate decoded video data based on the syntax elements extracted from the bitstream.

In general, video decoder 300 reconstructs a picture on a block-by-block basis. Video decoder 300 may perform a reconstruction operation on each block individually (where the block currently being reconstructed, i.e., decoded, may be referred to as a “current block”).

Entropy decoding unit 302 may entropy decode syntax elements defining quantized transform coefficients of a quantized transform coefficient block, as well as transform information, such as a quantization parameter (QP) and/or transform mode indication(s). Inverse quantization unit 306 may use the QP associated with the quantized transform coefficient block to determine a degree of quantization and, likewise, a degree of inverse quantization for inverse quantization unit 306 to apply. Inverse quantization unit 306 may, for example, perform a bitwise left-shift operation to inverse quantize the quantized transform coefficients. Inverse quantization unit 306 may thereby form a transform coefficient block including transform coefficients.

After inverse quantization unit 306 forms the transform coefficient block, inverse transform processing unit 308 may apply one or more inverse transforms to the transform coefficient block to generate a residual block associated with the current block. For example, inverse transform processing unit 308 may apply an inverse DCT, an inverse integer transform, an inverse Karhunen-Loeve transform (KLT), an inverse rotational transform, an inverse directional transform, or another inverse transform to the transform coefficient block.

Furthermore, prediction processing unit 304 generates a prediction block according to prediction information syntax elements that were entropy decoded by entropy decoding unit 302. For example, if the prediction information syntax elements indicate that the current block is inter-predicted, motion compensation unit 316 may generate the prediction block. In this case, the prediction information syntax elements may indicate a reference picture in DPB 314 from which to retrieve a reference block, as well as a motion vector identifying a location of the reference block in the reference picture relative to the location of the current block in the current picture. Motion compensation unit 316 may generally perform the inter-prediction process in a manner that is substantially similar to that described with respect to motion compensation unit 224 (FIG. 2).

As another example, if the prediction information syntax elements indicate that the current block is intra-predicted, intra-prediction unit 318 may generate the prediction block according to an intra-prediction mode indicated by the prediction information syntax elements. Again, intra-prediction unit 318 may generally perform the intra-prediction process in a manner that is substantially similar to that described with respect to intra-prediction unit 226 (FIG. 2). Intra-prediction unit 318 may retrieve data of neighboring samples to the current block from DPB 314.

Reconstruction unit 310 may reconstruct the current block using the prediction block and the residual block. For example, reconstruction unit 310 may add samples of the residual block to corresponding samples of the prediction block to reconstruct the current block.

Filter unit 312 may perform one or more filter operations on reconstructed blocks. For example, filter unit 312 may perform deblocking operations to reduce blockiness artifacts along edges of the reconstructed blocks. Operations of filter unit 312 are not necessarily performed in all examples.

Video decoder 300 may store the reconstructed blocks in DPB 314. For instance, in examples where operations of filter unit 312 are not performed, reconstruction unit 310 may store reconstructed blocks to DPB 314. In examples where operations of filter unit 312 are performed, filter unit 312 may store the filtered reconstructed blocks to DPB 314. As discussed above, DPB 314 may provide reference information, such as samples of a current picture for intra-prediction and previously decoded pictures for subsequent motion compensation, to prediction processing unit 304. Moreover, video decoder 300 may output decoded pictures (e.g., decoded video) from DPB 314 for subsequent presentation on a display device, such as display device 118 of FIG. 1.

In this manner, video decoder 300 represents an example of a video decoding device including a memory configured to store video data, and one or more processing units implemented in circuitry and configured to determine a quantization level for a coefficient of a current block, for quantization or inverse quantization, from a plurality of quantization levels, determine an offset value based on the quantization level, wherein the offset value is a first offset value based on the quantization level being a first quantization level or a second, different offset value based on the quantization level being a second quantization level, determine an inverse-quantization parameter for the coefficient based on the determined offset value, and perform inverse-quantization for the coefficient based on the determined inverse-quantization parameter.

Also, video decoder 300 represents an example of a video decoding device including a memory configured to store video data, and one or more processing units implemented in circuitry and configured to determine a quantizer for a coefficient, for inverse quantization, from at least a first quantizer and a second quantizer, determine an offset value based on the quantizer, wherein the offset value is a first offset value based on the quantizer being the first quantizer or a second, different offset value based on the quantizer being the second quantizer, determine an inverse-quantization parameter for the coefficient based on the determined offset value, and perform inverse-quantization for the coefficient based on the determined inverse-quantization parameter.

Also, video decoder 300 represents an example of a video decoding device including a memory configured to store video data, and one or more processing units implemented in circuitry and configured to determine a first quantizer for a first coefficient of a luma component of a current block, for inverse quantization, determine a first offset value for the first coefficient, determine a first inverse-quantization parameter for the first coefficient based on the determined first quantizer and the first offset value, perform inverse-quantization for the first coefficient based on the determined first inverse-quantization parameter, determine a second quantizer for a second coefficient of a chroma component of the current block, for inverse quantization, determine a second offset value for the second coefficient, the second offset value being different than the first offset value, determine a second inverse-quantization parameter for the second coefficient based on the determined second quantizer and the second offset value, and perform inverse-quantization for the second coefficient based on the determined second inverse-quantization parameter.

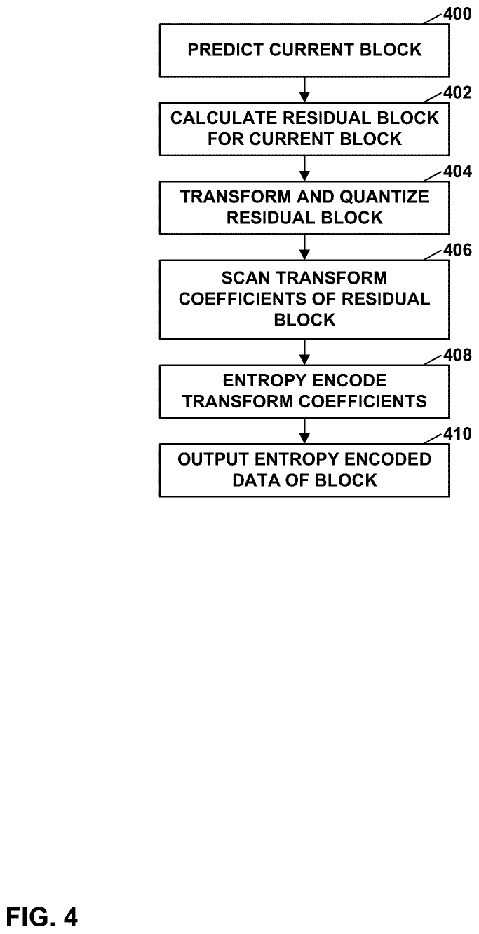

FIG. 4 is a flowchart illustrating an example method for encoding a current block in accordance with the techniques of this disclosure. The current block may be or include a current CU. Although described with respect to video encoder 200 (FIGS. 1 and 2), it should be understood that other devices may be configured to perform a method similar to that of FIG. 4.

In this example, video encoder 200 initially predicts the current block (400). For example, video encoder 200 may form a prediction block for the current block. Video encoder 200 may then calculate a residual block for the current block (402). To calculate the residual block, video encoder 200 may calculate a difference between the original, unencoded block and the prediction block for the current block. Video encoder 200 may then transform the residual block and quantize transform coefficients of the residual block (e.g., using techniques described in this disclosure) (404). Next, video encoder 200 may scan the quantized transform coefficients of the residual block (406). During the scan, or following the scan, video encoder 200 may entropy encode the transform coefficients (408). For example, video encoder 200 may encode the transform coefficients using CAVLC or CABAC. Video encoder 200 may then output the entropy encoded data of the block (410).

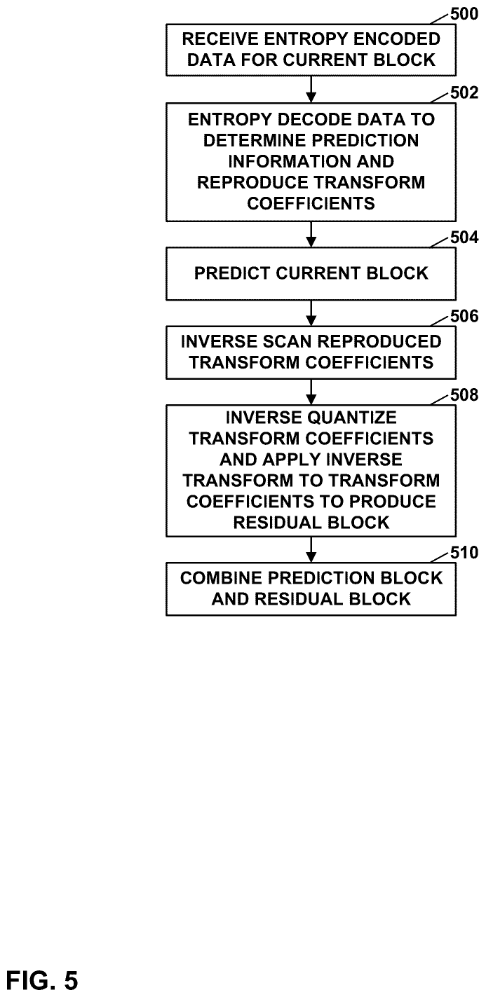

FIG. 5 is a flowchart illustrating an example method for decoding a current block of video data in accordance with the techniques of this disclosure. The current block may be or include a current CU. Although described with respect to video decoder 300 (FIGS. 1 and 3), it should be understood that other devices may be configured to perform a method similar to that of FIG. 5.

Video decoder 300 may receive entropy encoded data for the current block, such as entropy encoded prediction information and entropy encoded data for transform coefficients of a residual block corresponding to the current block (500). Video decoder 300 may entropy decode the entropy encoded data to determine prediction information for the current block and to reproduce transform coefficients of the residual block (502). Video decoder 300 may predict the current block (504), e.g., using an intra- or inter-prediction mode as indicated by the prediction information for the current block, to calculate a prediction block for the current block. Video decoder 300 may then inverse scan the reproduced transform coefficients (506), to create a block of quantized transform coefficients. Video decoder 300 may then inverse quantize the transform coefficients (e.g., using the techniques described in this disclosure) and apply an inverse transform to the transform coefficients to produce a residual block (508). Video decoder 300 may ultimately decode the current block by combining the prediction block and the residual block (510).

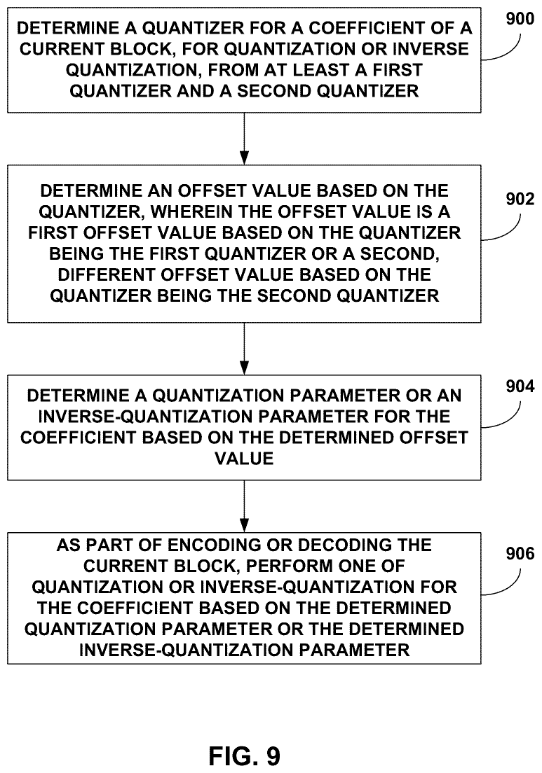

FIG. 9 is a flowchart illustrating a method of operation in accordance with one or more examples. For ease of illustration, the example of FIG. 9 is described with respect to video encoder 200 and video decoder 300. For example, one or more memories (e.g., memory 106, memory 120, video data memory 230, DPB 218, CPB memory 320, DPB 314, or some other memory) may be configured to store video data. Processing circuitry of video encoder 200 or video decoder 300 may be coupled to the one or more memories and configured to perform example techniques of FIG. 9.

Processing circuitry of video encoder 200 or video decoder 300 may determine a quantizer for a coefficient of a current block, for quantization or inverse quantization, from at least a first quantizer and a second quantizer (900). Examples of the first quantizer and the second quantizer are Q0 and Q1. The processing circuitry may be configured to determine the quantizer based on state machine 700 of FIG. 7.

Processing circuitry of video encoder 200 or video decoder 300 may determine an offset value based on the quantizer (902). The offset value may be a first offset value based on the quantizer being the first quantizer or a second, different offset value based on the quantizer being the second quantizer. In some examples, video encoder 200 may signal in a bitstream and video decoder 300 may parse from the bitstream the first offset value and the second offset value. In other examples, the first offset value and the second offset value may be pre-stored.

In one or more examples, a quantization level may also control which offset value is selected. For instance, the processing circuitry of video encoder 200 or video decoder 300 may determine a quantization level for the coefficient of a current block. Examples of the quantization level for the coefficients include integer values such as those illustrated in FIGS. 6 and 8. The quantization level may be represented as yᵢ. Video encoder 200 may determine yᵢ based on a rate-distortion calculation, and may signal information that video decoder 300 uses to determine yᵢ.

To determine the offset value, the processing circuitry of video encoder 200 or video decoder 300 may determine the offset value based on the quantizer and the quantization value. For example, the first offset value may be associated with the first quantizer and the quantization level (e.g., of the coefficient), and the first offset value may be different than offset values associated with the first quantizer and other quantization levels. The second offset value may be associated with the second quantizer and the quantization level (e.g., of the coefficient), and the second offset value may be different than offset values associated with the second quantizer and other quantization levels.

As one example, the quantization level of the coefficient may be one or negative one, and the other quantization levels are greater than one or less than negative one. Accordingly, in this example, if the quantizer is Q0, and the quantization level for the coefficient is one or negative one, then the offset value may be the first offset value. This first offset value may be different than the offset value for coefficients with a quantization level that is not one or negative one but have quantizer Q0. Similarly, if the quantizer is Q1, and the quantization level for the coefficient is one or negative one, then the offset value may be the second offset value. This second offset value may be different than the offset value for coefficients with a quantization level that is not one or negative one but have quantizer Q1. In this way, the processing circuitry of video encoder 200 and video decoder 300 may assign a separate offset for quantization level equal to 1 for the coefficients that are mapped to coefficient level +/−1, and the rest of the levels are assigned a different quantization offset.

As another example, an absolute value of the quantization level may be less than a threshold, and an absolute value of the other quantization levels may be greater than the threshold. Accordingly, in this example, if the quantizer is Q0, and the quantization level for the coefficient is less than the threshold, then the offset value may be the first offset value. This first offset value may be different than the offset value for coefficients with a quantization level that is greater than the threshold but have quantizer Q0. Similarly, if the quantizer is Q1, and the quantization level for the coefficient is less than the threshold, then the offset value may be the second offset value. This second offset value may be different than the offset value for coefficients with a quantization level that is greater than the threshold but have quantizer Q1. In this way, the processing circuitry of video encoder 200 and video decoder 300 may assign a separate offset for absolute quantization levels less than a threshold (e.g. 4) and the rest of the levels are assigned a different quantization offset.

As another example, each of the first offset value and the offset values associated with the other quantization levels associated with the first quantizer are different, and each of the second offset value and the offset values associated with the other quantization levels associated with the second quantizer are different. Accordingly, in this example, if the quantizer is Q0, and the quantization level is at a particular quantization level, then the offset value may be the first offset value. This first offset value may be different than the offset value for coefficients with a quantization level that is different than the particular quantization level but with quantizer Q0. Similarly, if the quantizer is Q1, and the quantization level is at a particular quantization level, then the offset value may be the second offset value. This second offset value may be different than the offset value for coefficients with a quantization level that is different than the particular quantization level but with quantizer Q1. In this way, the processing circuitry of video encoder 200 and video decoder 300 may assign a different quantization offset value to each quantization level (i.e., each level is assigned a different quantization offset).

In some examples, the first offset value is associated with the first quantizer and the coefficient being for a luma block, and the first offset value is different than offset values associated with the first quantizer and coefficients being for a chroma block. The second offset value is associated with the second quantizer and the coefficient being for the luma block, and the second offset value is different than offset values associated with the second quantizer and coefficients being for a chroma block.

The processing circuitry of video encoder 200 or video decoder 300 may determine a quantization parameter or an inverse-quantization parameter for the coefficient based on the determined offset value (904). For example, the processing circuitry may determine yᵢ+offset value as the quantization parameter or the inverse-quantization parameter.

The processing circuitry of video encoder 200 or video decoder 300 may, as part of encoding or decoding the current block, perform one of quantization or inverse-quantization for the coefficient based on the determined quantization parameter or the determined inverse-quantization parameter (906). For example, video encoder 200 may perform quantization by determining (yᵢ+offset value)/(step size). Video decoder 300 may perform inverse-quantization by determining (yᵢ+offset value)*(step size). The step size may be signaled or determined using non-signaling techniques.

For example, to encode the current block, video encoder 200 may determine a prediction block for the current block, and determine the coefficient based on a difference between the prediction block and the current block. For instance, the difference between the prediction block and the current block may be a residual value that video encoder 200 transforms or does not transform (e.g., if transform skip is enabled) to generate the coefficient.

In this example, to perform one of quantization or inverse-quantization for the coefficient based on the determined quantization parameter or the determined inverse-quantization parameter, video encoder 200 may perform quantization for the coefficient based on the determined quantization parameter to generate a quantized coefficient. Video encoder 200 may signal information indicative of the quantized coefficient.

As another example, to perform one of quantization or inverse-quantization for the coefficient based on the determined quantization parameter or the determined inverse-quantization parameter, video decoder 300 may perform inverse-quantization for the coefficient based on the determined inverse-quantization parameter to generate an inverse-quantized coefficient. In this example, video decoder 300 may decode the current block. To decode the current block, video decoder 300 may be configured to determine residual values for the current block based on the inverse-quantized coefficient. For instance, if transform is enabled, video decoder 300 may inverse-transform the inverse-quantized coefficient to generate a residual value. If transform skip is enabled, the inverse-quantized coefficient may be the residual value.

In this example, video decoder 300 may determine a prediction block for the current block. Video decoder 300 may add the prediction block to the residual values to reconstruct the current block.

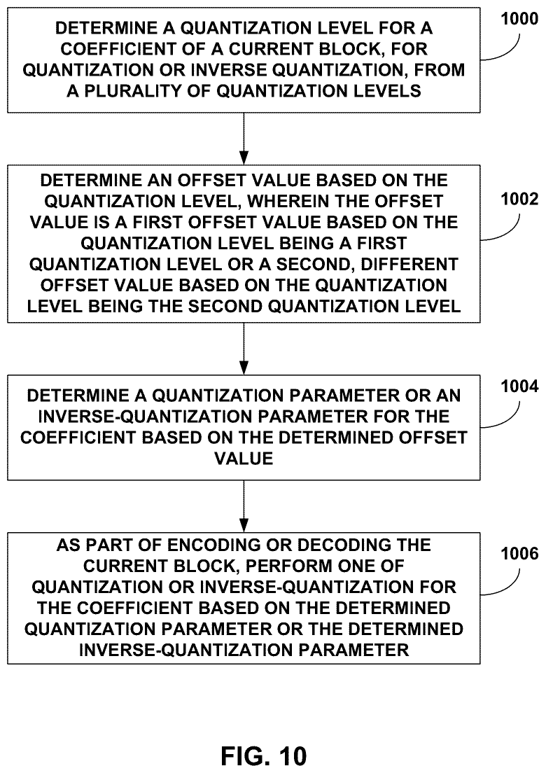

FIG. 10 is a flowchart illustrating a method of operation in accordance with one or more examples. For ease of illustration, the example of FIG. 10 is described with respect to video encoder 200 and video decoder 300. For example, one or more memories (e.g., memory 106, memory 120, video data memory 230, DPB 218, CPB memory 320, DPB 314, or some other memory) may be configured to store video data. Processing circuitry of video encoder 200 or video decoder 300 may be coupled to the one or more memories and configured to perform example techniques of FIG. 10.

In the example of FIG. 9, the processing circuitry of video encoder 200 or video decoder 300 may determine an offset value based on the quantizer. That is, whether the quantizer was Q0 or Q1 controlled whether the offset value would be the first offset value or the second offset value. In FIG. 9, the quantization level may then be an additional factor in determining whether the offset value would be the first offset value or the second offset value. Also, in FIG. 9, whether a coefficient is for a luma or chroma block may be another factor (e.g., in addition to or instead of quantization level) in determining whether the offset value would be the first offset value or the second offset value.

In the example of FIG. 10, the processing circuitry of video encoder 200 or video decoder 300 may determine an offset value based on the quantization level. That is, in FIG. 10, the quantization level may control whether the offset value would be the first offset value, the second offset value, or possibly some other offset value. In FIG. 10, the quantizer (e.g., Q0 or Q) may then be an additional factor in determining whether the offset value would be the first offset value or the second offset value, or some other offset value. In FIG. 10, whether a coefficient is for a luma or chroma block may be another factor (e.g., in addition to or instead of quantizer) in determining whether the offset value would be the first offset value or the second offset value.

For example, processing circuitry of video encoder 200 or video decoder 300 may determine a quantization level for a coefficient of a current block, for quantization or inverse quantization, from a plurality of quantization levels (1000). Examples of the quantization level for the coefficients include integer values such as those illustrated in FIGS. 6 and 8. The quantization level may be represented as yᵢ. Video encoder 200 may determine yᵢ based on a rate-distortion calculation, and may signal information that video decoder 300 uses to determine yᵢ.

Video encoder 200 and video decoder 300 may determine an offset value based on the quantization level (1002). The offset value is a first offset value based on the quantization level being a first quantization level or a second, different offset value based on the quantization level being a second quantization level. Other offset values for other quantization levels are possible.

For instance, the first offset value may be based on the quantization level being 1 or −1, and the second offset value may be based on the quantization level being greater than 1 or less than −1. That is, if the quantization level of the coefficient is one or negative one, the processing circuitry of video encoder 200 or video decoder 300 may determine the offset value is equal to the first offset value. If the quantization level of the coefficient is not one or negative one, the processing circuitry of video encoder 200 or video decoder 300 may determine the offset value is equal to the second offset value.

As another example, the first offset value may be based on an absolute value of the quantization level being less than a threshold (e.g., 4), and the second offset value may be based on an absolute value of the quantization level being greater than the threshold. That is, if the absolute value of quantization level of the coefficient is less than the threshold, the processing circuitry of video encoder 200 or video decoder 300 may determine the offset value is equal to the first offset value. If the absolute value of the quantization level of the coefficient is greater than the threshold, the processing circuitry of video encoder 200 or video decoder 300 may determine the offset value is equal to the second offset value.

As another example, the first offset value and the second offset value may always be different (e.g., each quantization level is associated with a different offset value). That is, if the quantization level of the coefficient is at a first quantization level, the processing circuitry of video encoder 200 or video decoder 300 may determine the offset value is equal to the first offset value. If the quantization level of the coefficient is at a second quantization level, the processing circuitry of video encoder 200 or video decoder 300 may determine the offset value is equal to the second offset value, and so forth.

In one or more of the above examples described with respect to FIG. 10, the quantization level may control the offset value, regardless of the quantizer. For a quantization level, the offset value is the same for Q0 and Q1, but the offset value may be different for different quantization levels.

However, in some examples, whether the processing circuitry of video encoder 200 or video decoder 300 determines the first offset value or the second offset value may be dependent of whether the quantizer is Q0 or Q1. For instance, both the quantizer and the quantization level may control the offset value. The processing circuitry of video encoder 200 or video decoder 300 may determine a first offset value for the quantizer being Q0 and the quantization level being a first quantization level, a second offset value for the quantizer being Q1 and the quantization level being the first quantization level, a third offset value for the quantizer being Q0 and the quantization level being a second quantization level, and a fourth offset value for the quantizer being Q1 and the quantization level being the second quantization level. At least two of the first, second, third, and fourth offset values may be different.

For example, assume that a coefficient is a first coefficient, an offset value is an offset value for the first coefficient, a quantization level is the first quantization level for the first coefficient, a quantizer for the first coefficient is the first quantizer, the quantization parameter is a first quantization parameter, and the inverse-quantization parameter is a first inverse-quantization parameter. In this example, video encoder 200 and video decoder 300 may be configured to determine a quantizer for a second coefficient, for quantization or inverse quantization, wherein the quantizer for the second coefficient is the second quantizer.

Video encoder 200 and video decoder 300 may determine that a quantization level for the second coefficient is the first quantization level, and determine an offset value for the second coefficient based on the quantizer for the second coefficient being the second quantizer, and the quantization level being the first quantization level. In this example, the offset value for the second coefficient is different than the offset value for the first coefficient based on the quantizer for the first and second coefficient being different, while the quantization level for the first and second coefficient is the same. That is, although the quantization level for the first and second coefficient is the same, the offset value for the first and second coefficient may be different because the quantizer for the first and second coefficient is different.

The processing circuitry of video encoder 200 or video decoder 300 may determine a quantization parameter or an inverse-quantization parameter for the coefficient based on the determined offset value (1004). For example, the processing circuitry may determine yᵢ+offset value as the quantization parameter or the inverse-quantization parameter.

The processing circuitry of video encoder 200 or video decoder 300 may, as part of encoding or decoding the current block, perform one of quantization or inverse-quantization for the coefficient based on the determined quantization parameter or the determined inverse-quantization parameter (1006). For example, video encoder 200 may perform quantization by determining (yᵢ+offset value)/(step size). Video decoder 300 may perform inverse-quantization by determining (yᵢ+offset value)*(step size). The step size may be signaled or determined using non-signaling techniques.

For example, to encode the current block, video encoder 200 may determine a prediction block for the current block, and determine the coefficient based on a difference between the prediction block and the current block. For instance, the difference between the prediction block and the current block may be a residual value that video encoder 200 transforms or does not transform (e.g., if transform skip is enabled) to generate the coefficient.

In this example, to perform one of quantization or inverse-quantization for the coefficient based on the determined quantization parameter or the determined inverse-quantization parameter, video encoder 200 may perform quantization for the coefficient based on the determined quantization parameter to generate a quantized coefficient. Video encoder 200 may signal information indicative of the quantized coefficient.

As another example, to perform one of quantization or inverse-quantization for the coefficient based on the determined quantization parameter or the determined inverse-quantization parameter, video decoder 300 may perform inverse-quantization for the coefficient based on the determined inverse-quantization parameter to generate an inverse-quantized coefficient. In this example, video decoder 300 may decode the current block. To decode the current block, video decoder 300 may be configured to determine residual values for the current block based on the inverse-quantized coefficient. For instance, if transform is enabled, video decoder 300 may inverse-transform the inverse-quantized coefficient to generate a residual value. If transform skip is enabled, the inverse-quantized coefficient may be the residual value.

In this example, video decoder 300 may determine a prediction block for the current block. Video decoder 300 may add the prediction block to the residual values to reconstruct the current block.

The following numbered clauses illustrate one or more aspects of the devices and techniques described in this disclosure.

Clause 1A: A method of encoding or decoding video data, the method comprising: determining a quantizer for a coefficient, for quantization or inverse quantization, from at least a first quantizer and a second quantizer; determining an offset value based on the quantizer, wherein the offset value is a first offset value based on the quantizer being the first quantizer or a second, different offset value based on the quantizer being the second quantizer; determining a quantization parameter or an inverse-quantization parameter for the coefficient based on the determined offset value; and performing one of quantization or inverse-quantization for the coefficient based on the determined quantization parameter or the determined inverse-quantization parameter.

Clause 2A: The method of clause 1A, wherein determining the offset value comprises one of: determining the offset value based on signaling; determining the offset value based on derived information, without signaling; or determining the offset value based on pre-stored information.

Clause 3A. A method of encoding or decoding video data, the method comprising: determining a first quantizer for a first coefficient of a luma component of a current block, for quantization or inverse quantization; determining a first offset value for the first coefficient; determining a first quantization parameter or a first inverse-quantization parameter for the first coefficient based on the determined first quantizer and the first offset value; performing one of quantization or inverse-quantization for the first coefficient based on the determined first quantization parameter or the determined first inverse-quantization parameter; determining a second quantizer for a second coefficient of a chroma component of the current block, for quantization or inverse quantization; determining a second offset value for the second coefficient, the second offset value being different than the first offset value; determining a second quantization parameter or a second inverse-quantization parameter for the second coefficient based on the determined second quantizer and the second offset value; and performing one of quantization or inverse-quantization for the second coefficient based on the determined second quantization parameter or the determined second inverse-quantization parameter.

Clause 4A. The method of clause 3A, wherein determining the first offset value for the first coefficient comprises determining the first offset value based on the first coefficient being for the luma component, and wherein determining the second offset value for the second coefficient comprises determining the second offset value based on the second coefficient being for the chroma component.

Clause 5A. A method comprising any combination of clauses 1A-4A.

Clause 6A. A device for encoding or decoding video data, the device comprising: memory configured to store the video data; and processing circuitry coupled to the memory, wherein the processing circuitry is configured to perform the method of any one or combination of clauses 1A-5A.

Clause 7A. The device of clause 6, further comprising a display configured to display decoded video data.

Clause 8A. The device of any of clauses 6A and 7A, wherein the device comprises one or more of a camera, a computer, a mobile device, a broadcast receiver device, or a set-top box.

Clause 9A. The device of any of clauses 6A-8A, wherein the device comprises a video decoder.

Clause 10A. The device of any of clauses 6A-9A, wherein the device comprises a video encoder.

Clause 11A. A computer-readable storage medium having stored thereon instructions that, when executed, cause one or more processors to perform the method of any one or combination of clauses 1A-5A.

Clause 12A. A device for encoding or decoding video data, the device comprising means for performing the method of any one or combination of clauses 1A-5A.

Clause 1. A method of processing video data, the method comprising: determining a quantization level for a coefficient of a current block from a plurality of quantization levels; determining an offset value based on the quantization level, wherein the offset value is a first offset value based on the quantization level being a first quantization level or a second, different offset value based on the quantization level being a second quantization level; determining a quantization parameter or an inverse-quantization parameter for the coefficient based on the determined offset value; and as part of encoding or decoding the current block, performing one of quantization or inverse-quantization for the coefficient based on the determined quantization parameter or the determined inverse-quantization parameter.

Clause 2. The method of clause 1, further comprising: determining a quantizer for the coefficient from at least a first quantizer and a second quantizer,
wherein determining the offset value comprises determining the offset value based on the quantization level and the quantizer.

Clause 3. The method of clause 2, wherein the coefficient is a first coefficient, the offset value is an offset value for the first coefficient, the quantization level is the first quantization level for the first coefficient, the quantizer for the first coefficient is the first quantizer, the quantization parameter is a first quantization parameter, and the inverse-quantization parameter is a first inverse-quantization parameter, the method further comprising: determining a quantizer for a second coefficient, for quantization or inverse quantization, wherein the quantizer for the second coefficient is the second quantizer; determining that a quantization level for the second coefficient is the first quantization level; determining an offset value for the second coefficient based on the quantizer for the second coefficient being the second quantizer, and the quantization level being the first quantization level, wherein the offset value for the second coefficient is different than the offset value for the first coefficient based on the quantizer for the first and second coefficient being different, while the quantization level for the first and second coefficient is the same; determining a second quantization parameter or a second inverse-quantization parameter for the second coefficient based on the determined offset value for the second coefficient; and performing one of quantization or inverse-quantization for the second coefficient based on the determined second quantization parameter or the determined second inverse-quantization parameter.

Clause 4. The method of any of clauses 1-3, wherein each of the plurality of quantization levels is associated with a different offset value.

Clause 5. The method of any of clauses 1-3, wherein determining the offset value comprises: determining that the offset value is the first offset value based on the quantization level being one or negative one, or determining that the offset value is the second offset value based on the quantization level being greater than one or less than negative one.

Clause 6. The method of any of clauses 1-3, wherein determining the offset value comprises: determining that the offset value is the first offset value based on an absolute value of the quantization level being less than a threshold, or determining that the offset value is the second offset value based on the absolute value of the quantization level being greater than the threshold.

Clause 7. The method of any of clauses 1-6, wherein the first offset value is associated with the first quantization level and the coefficient being for a luma block, and the first offset value is different than offset values associated with the first quantization level and coefficients being for a chroma block, and wherein the second offset value is associated with the second quantization level and the coefficient being for the luma block, and the second offset value is different than offset values associated with the second quantization level and coefficients being for the chroma block.

Clause 8. The method of any of clauses 1-7, further comprising encoding the current block, wherein encoding the current block comprises: determining a prediction block for the current block; and determining the coefficient based on a difference between the prediction block and the current block, wherein performing one of quantization or inverse-quantization for the coefficient based on the determined quantization parameter or the determined inverse-quantization parameter comprises performing quantization for the coefficient based on the determined quantization parameter to generate a quantized coefficient, wherein encoding the current block further comprises signaling information indicative of the quantized coefficient.

Clause 9. The method of any of clauses 1-7, wherein performing one of quantization or inverse-quantization for the coefficient based on the determined quantization parameter or the determined inverse-quantization parameter comprises performing inverse-quantization for the coefficient based on the determined inverse-quantization parameter to generate an inverse-quantized coefficient, the method further comprising decoding the current block, wherein decoding the current block: determining residual values for the current block based on the inverse-quantized coefficient; determining a prediction block for the current block; and adding the prediction block to the residual values to reconstruct the current block.

Clause 10. A device for processing video data, the device comprising: one or more memories configured to store the video data; and processing circuitry coupled to the one or more memories, wherein the processing circuitry is configured to: determine a quantization level for a coefficient of a current block from a plurality of quantization levels; determine an offset value based on the quantization level, wherein the offset value is a first offset value based on the quantization level being a first quantization level or a second, different offset value based on the quantization level being a second quantization level; determine a quantization parameter or an inverse-quantization parameter for the coefficient based on the determined offset value; and as part of encoding or decoding the current block, perform one of quantization or inverse-quantization for the coefficient based on the determined quantization parameter or the determined inverse-quantization parameter.

Clause 11. The device of clause 10, wherein the processing circuitry is configured to: determine a quantizer for the coefficient from at least a first quantizer and a second quantizer, wherein to determine the offset value, the processing circuitry is configured to determine the offset value based on the quantization level and the quantizer.

Clause 12. The device of clause 11, wherein the coefficient is a first coefficient, the offset value is an offset value for the first coefficient, the quantization level is the first quantization level for the first coefficient, the quantizer for the first coefficient is the first quantizer, the quantization parameter is a first quantization parameter, and the inverse-quantization parameter is a first inverse-quantization parameter, and wherein the processing circuitry is configured to: determine a quantizer for a second coefficient, for quantization or inverse quantization, wherein the quantizer for the second coefficient is the second quantizer; determining that a quantization level for the second coefficient is the first quantization level; determine an offset value for the second coefficient based on the quantizer for the second coefficient being the second quantizer, and the quantization level being the first quantization level, wherein the offset value for the second coefficient is different than the offset value for the first coefficient based on the quantizer for the first and second coefficient being different, while the quantization level for the first and second coefficient is the same; determine a second quantization parameter or a second inverse-quantization parameter for the second coefficient based on the determined offset value for the second coefficient; and perform one of quantization or inverse-quantization for the second coefficient based on the determined second quantization parameter or the determined second inverse-quantization parameter.

Clause 13. The device of any of clauses 10-12, wherein each of the plurality of quantization levels is associated with a different offset value.

Clause 14. The device of any of clauses 10-12, wherein to determine the offset value, the processing circuitry is configured to: determine that the offset value is the first offset value based on the quantization level being one or negative one, or determine that the offset value is the second offset value based on the quantization level being greater than one or less than negative one.

Clause 15. The device of any of clauses 10-12, wherein to determine the offset value, the processing circuitry is configured to: determine that the offset value is the first offset value based on an absolute value of the quantization level being less than a threshold, or determine that the offset value is the second offset value based on the absolute value of the quantization level being greater than the threshold.

Clause 16. The device of any of clauses 10-15, wherein the first offset value is associated with the first quantization level and the coefficient being for a luma block, and the first offset value is different than offset values associated with the first quantization level and coefficients being for a chroma block, and wherein the second offset value is associated with the second quantization level and the coefficient being for the luma block, and the second offset value is different than offset values associated with the second quantization level and coefficients being for the chroma block.

Clause 17. The device of any of clauses 10-16, wherein the processing circuitry is configured to encode the current block, wherein to encode the current block, the processing circuitry is configured to: determine a prediction block for the current block; and determine the coefficient based on a difference between the prediction block and the current block, wherein to perform one of quantization or inverse-quantization for the coefficient based on the determined quantization parameter or the determined inverse-quantization parameter, the processing circuitry is configured to perform quantization for the coefficient based on the determined quantization parameter to generate a quantized coefficient, wherein to encode the current block, the processing circuitry is further configured to signal information indicative of the quantized coefficient.

Clause 18. The device of any of clauses 10-16, wherein to perform one of quantization or inverse-quantization for the coefficient based on the determined quantization parameter or the determined inverse-quantization parameter, the processing circuitry is configured to perform inverse-quantization for the coefficient based on the determined inverse-quantization parameter to generate an inverse-quantized coefficient, wherein the processing circuitry is further configured to decode the current block, and wherein to decode the current block, the processing circuitry is configured to: determine residual values for the current block based on the inverse-quantized coefficient; determine a prediction block for the current block; and add the prediction block to the residual values to reconstruct the current block.

Clause 19. A computer-readable storage medium storing instructions thereon that when executed cause one or more processors to: determine a quantization level for a coefficient of a current block from a plurality of quantization levels; determine an offset value based on the quantization level, wherein the offset value is a first offset value based on the quantization level being a first quantization level or a second, different offset value based on the quantization level being a second quantization level; determine a quantization parameter or an inverse-quantization parameter for the coefficient based on the determined offset value; and as part of encoding or decoding the current block, perform one of quantization or inverse-quantization for the coefficient based on the determined quantization parameter or the determined inverse-quantization parameter.

Clause 20. The computer-readable storage medium of clause 19, wherein each of the plurality of quantization levels is associated with a different offset value.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media may include one or more of RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of processing video data, the method comprising:
determining a quantization level for a coefficient of a current block from a plurality of quantization levels;
determining an offset value based on the quantization level, wherein the offset value is a first offset value based on the quantization level being a first quantization level or a second, different offset value based on the quantization level being a second quantization level;
determining a quantization parameter or an inverse-quantization parameter for the coefficient based on the determined offset value; and
as part of encoding or decoding the current block, performing one of quantization or inverse-quantization for the coefficient based on the determined quantization parameter or the determined inverse-quantization parameter.

2. The method of claim 1, further comprising:
determining a quantizer for the coefficient from at least a first quantizer and a second quantizer,
wherein determining the offset value comprises determining the offset value based on the quantization level and the quantizer.

3. The method of claim 2, wherein the coefficient is a first coefficient, the offset value is an offset value for the first coefficient, the quantization level is the first quantization level for the first coefficient, the quantizer for the first coefficient is the first quantizer, the quantization parameter is a first quantization parameter, and the inverse-quantization parameter is a first inverse-quantization parameter, the method further comprising:
determining a quantizer for a second coefficient, for quantization or inverse quantization, wherein the quantizer for the second coefficient is the second quantizer;
determining that a quantization level for the second coefficient is the first quantization level;
determining an offset value for the second coefficient based on the quantizer for the second coefficient being the second quantizer, and the quantization level being the first quantization level, wherein the offset value for the second coefficient is different than the offset value for the first coefficient based on the quantizer for the first and second coefficient being different, while the quantization level for the first and second coefficient is the same;
determining a second quantization parameter or a second inverse-quantization parameter for the second coefficient based on the determined offset value for the second coefficient; and
performing one of quantization or inverse-quantization for the second coefficient based on the determined second quantization parameter or the determined second inverse-quantization parameter.

4. The method of claim 1, wherein each of the plurality of quantization levels is associated with a different offset value.

5. The method of claim 1, wherein determining the offset value comprises:
determining that the offset value is the first offset value based on the quantization level being one or negative one, or
determining that the offset value is the second offset value based on the quantization level being greater than one or less than negative one.

6. The method of claim 1, wherein determining the offset value comprises:
determining that the offset value is the first offset value based on an absolute value of the quantization level being less than a threshold, or
determining that the offset value is the second offset value based on the absolute value of the quantization level being greater than the threshold.

7. The method of claim 1,
wherein the first offset value is associated with the first quantization level and the coefficient being for a luma block, and the first offset value is different than offset values associated with the first quantization level and coefficients being for a chroma block, and
wherein the second offset value is associated with the second quantization level and the coefficient being for the luma block, and the second offset value is different than offset values associated with the second quantization level and coefficients being for the chroma block.

8. The method of claim 1, further comprising encoding the current block, wherein encoding the current block comprises:
determining a prediction block for the current block; and
determining the coefficient based on a difference between the prediction block and the current block,
wherein performing one of quantization or inverse-quantization for the coefficient based on the determined quantization parameter or the determined inverse-quantization parameter comprises performing quantization for the coefficient based on the determined quantization parameter to generate a quantized coefficient,
wherein encoding the current block further comprises signaling information indicative of the quantized coefficient.

9. The method of claim 1, wherein performing one of quantization or inverse-quantization for the coefficient based on the determined quantization parameter or the determined inverse-quantization parameter comprises performing inverse-quantization for the coefficient based on the determined inverse-quantization parameter to generate an inverse-quantized coefficient, the method further comprising decoding the current block, wherein decoding the current block:
determining residual values for the current block based on the inverse-quantized coefficient;
determining a prediction block for the current block; and
adding the prediction block to the residual values to reconstruct the current block.

10. A device for processing video data, the device comprising:
one or more memories configured to store the video data; and
processing circuitry coupled to the one or more memories, wherein the processing circuitry is configured to:
determine a quantization level for a coefficient of a current block from a plurality of quantization levels;
determine an offset value based on the quantization level, wherein the offset value is a first offset value based on the quantization level being a first quantization level or a second, different offset value based on the quantization level being a second quantization level;
determine a quantization parameter or an inverse-quantization parameter for the coefficient based on the determined offset value; and
as part of encoding or decoding the current block, perform one of quantization or inverse-quantization for the coefficient based on the determined quantization parameter or the determined inverse-quantization parameter.

11. The device of claim 10, wherein the processing circuitry is configured to:
determine a quantizer for the coefficient from at least a first quantizer and a second quantizer,
wherein to determine the offset value, the processing circuitry is configured to determine the offset value based on the quantization level and the quantizer.

12. The device of claim 11, wherein the coefficient is a first coefficient, the offset value is an offset value for the first coefficient, the quantization level is the first quantization level for the first coefficient, the quantizer for the first coefficient is the first quantizer, the quantization parameter is a first quantization parameter, and the inverse-quantization parameter is a first inverse-quantization parameter, and wherein the processing circuitry is configured to:
determine a quantizer for a second coefficient, for quantization or inverse quantization, wherein the quantizer for the second coefficient is the second quantizer; determining that a quantization level for the second coefficient is the first quantization level;
determine an offset value for the second coefficient based on the quantizer for the second coefficient being the second quantizer, and the quantization level being the first quantization level, wherein the offset value for the second coefficient is different than the offset value for the first coefficient based on the quantizer for the first and second coefficient being different, while the quantization level for the first and second coefficient is the same;
determine a second quantization parameter or a second inverse-quantization parameter for the second coefficient based on the determined offset value for the second coefficient; and
perform one of quantization or inverse-quantization for the second coefficient based on the determined second quantization parameter or the determined second inverse-quantization parameter.

13. The device of claim 10, wherein each of the plurality of quantization levels is associated with a different offset value.

14. The device of claim 10, wherein to determine the offset value, the processing circuitry is configured to:
determine that the offset value is the first offset value based on the quantization level being one or negative one, or
determine that the offset value is the second offset value based on the quantization level being greater than one or less than negative one.

15. The device of claim 10, wherein to determine the offset value, the processing circuitry is configured to:
determine that the offset value is the first offset value based on an absolute value of the quantization level being less than a threshold, or
determine that the offset value is the second offset value based on the absolute value of the quantization level being greater than the threshold.

16. The device of claim 10,
wherein the first offset value is associated with the first quantization level and the coefficient being for a luma block, and the first offset value is different than offset values associated with the first quantization level and coefficients being for a chroma block, and
wherein the second offset value is associated with the second quantization level and the coefficient being for the luma block, and the second offset value is different than offset values associated with the second quantization level and coefficients being for the chroma block.

17. The device of claim 10, wherein the processing circuitry is configured to encode the current block, wherein to encode the current block, the processing circuitry is configured to:
determine a prediction block for the current block; and
determine the coefficient based on a difference between the prediction block and the current block,
wherein to perform one of quantization or inverse-quantization for the coefficient based on the determined quantization parameter or the determined inverse-quantization parameter, the processing circuitry is configured to perform quantization for the coefficient based on the determined quantization parameter to generate a quantized coefficient,
wherein to encode the current block, the processing circuitry is further configured to signal information indicative of the quantized coefficient.

18. The device of claim 10, wherein to perform one of quantization or inverse-quantization for the coefficient based on the determined quantization parameter or the determined inverse-quantization parameter, the processing circuitry is configured to perform inverse-quantization for the coefficient based on the determined inverse-quantization parameter to generate an inverse-quantized coefficient, wherein the processing circuitry is further configured to decode the current block, and wherein to decode the current block, the processing circuitry is configured to:
determine residual values for the current block based on the inverse-quantized coefficient;
determine a prediction block for the current block; and
add the prediction block to the residual values to reconstruct the current block.

19. A computer-readable storage medium storing instructions thereon that when executed cause one or more processors to:
determine a quantization level for a coefficient of a current block from a plurality of quantization levels;
determine an offset value based on the quantization level, wherein the offset value is a first offset value based on the quantization level being a first quantization level or a second, different offset value based on the quantization level being a second quantization level;
determine a quantization parameter or an inverse-quantization parameter for the coefficient based on the determined offset value; and
as part of encoding or decoding the current block, perform one of quantization or inverse-quantization for the coefficient based on the determined quantization parameter or the determined inverse-quantization parameter.

20. The computer-readable storage medium of claim 19, wherein each of the plurality of quantization levels is associated with a different offset value.
